(19) United States
(12) Patent Application Publication
(10) Pub. No.: US 2023/0312314 A1
(43) Pub. Date: Oct. 5, 2023

(54) VEHICLE IMMOBILIZER

(71) Applicants: Dave Clayton, Castro Vailey, CA (US); Claude Michel, Redwood City, CA (US); Shrikrishna Shivakumar, Fremont, CA (US); Vimal Kumar Viswanathan, Union City, CA (US)

(72) Inventors: Dave Clayton, Castro Vailey, CA (US); Claude Michel, Redwood City, CA (US); Shrikrishna Shivakumar, Fremont, CA (US); Vimal Kumar Viswanathan, Union City, CA (US)

(21) Appl. No.: 17/657,694

(22) Filed: Apr. 1, 2022

(51) Int. Cl. B66F 7/06; E01F 13/12; B66F 5/02

(52) U.S. Cl. CPC B66F 7/065; B66F 7/0625; E01F 13/12; B66F 5/02

(57) ABSTRACT

A vehicle immobilizer system comprised of at least one deployable, remotely actuated lift system. The lift system is transported by a movable frame which can be remotely operated. The movable frame suspends the lift system during transport. However, during the lifting operation, the lift system bears the weight of the vehicle, while the movable frame does not. As a result, the movable frame can be of lightweight construction while the lift system can be robust. The lift system supports a universal docking plate which is designed to contact the suspect vehicle and suspend it without damaging it.

### CROSS-REFERENCE TO RELATED APPLICATIONS

This application claims priority benefit from U.S. Provisional Application No. 63/200,920, filed on Apr. 2, 2021. The patent application identified above is incorporated here by reference in its entirety to provide continuity of disclosure.

### FIELD OF THE INVENTION

The present invention relates to an apparatus and method for immobilizing vehicles.

### BACKGROUND OF THE INVENTION

Police conduct approximately 20 million traffic stops every year, according to the Stanford Open Policing Project. They are designed to discourage unsafe driving and, in some situations, identify drivers who are capable of more serious crimes. Each traffic stop, for the officer, is an unknown danger. The state of mind of the driver is unknown, as is the situation within the suspect vehicle. Hence, routine traffic stops are extremely dangerous for both the officer and the suspect.

The United States Department of Justice, Office of Justice Program reports that almost one-third of the officers killed in the line of duty are involved in traffic stops. Routine Stops, Second Edition NCJ Number 72541, 1980.

Likewise, a recent paper published by the U.S. Department of Justice indicates that the most common type of self-initiated police activity which results in a fatality was the common traffic stop. In fact, the number of officers shot and killed while conducting traffic stops nearly doubled in the years between 2010 and 2016. Of these deaths, the Department of Justice reports that 49% result during contact with a suspect vehicle. Making it Safer: A Study of Law Enforcement Fatalities Between 2010 and 2016. The National Association of Police Organization has also recognized that traffic stops are inherently dangerous and risky and pose a significant threat to the physical safety of law enforcement officers. The NAPO further recognizes that it is not uncommon for routine traffic stops to escalate into a violent situation. United States Supreme Court Amicus Brief, National Association of Police Organization McSpadden, S.R. (1998).

Police officers face many risks during routine traffic stops of suspect vehicles. One significant risk is that the suspect vehicle will flee the scene, thereby endangering the officers involved and the public at large. Officer training in so called “pursuit intervention techniques” has alleviated some of the safety issues with traffic stops. In general, these techniques are designed to force the suspect vehicle from the road during pursuit. However, these techniques alone are insufficient and often result in traffic accidents which bring the risk of injury or death to both suspects, the public and the officers.

The prior art has attempted to address the dangerous problems created by traffic stops, but all have fallen short.

For example, U.S. Pat. No. 6,623,205 to Ramirez discloses a vehicle disabling device. The device disclosed has a carriage that is projected from a launch platform using a plurality of elongated extension tubes. The plurality of elongated extension tubes are pneumatically actuated. The carriage includes wheels and is adapted to move in front of an official vehicle. The carriage includes arms pivotally connected to the carriage. Spikes are provided on the arms which puncture the tires of the suspect vehicle. However, Ramirez fails to disclose a system that may be used without damage to a suspect vehicle or which can be used at any extended distance from the suspect vehicle.

As another example, U.S. Pat. No. 7,896,113 to Ramirez discloses a robotic system adapted to deploy from a police vehicle for inspecting a suspect vehicle. The system discloses a robot unit and a carrier unit. The robot unit includes a base having a drive system responsive to a control unit having a transceiver, and a camera mounted for viewing the suspect vehicle. A display is positioned inside the police vehicle to show images from the camera. A remote control unit enables the user to control the robot unit. The carrier unit includes a housing that moves between a raised position for carrying the robot unit, and a lowered position for deploying the robot unit. However, Ramirez does not disclose a means for immobilizing a vehicle, but only for observing it.

U.S. Publication No. 2020/0223675 to Wen discloses a fixed tool which utilizes electrically actuated scissor jacks to lift a vehicle. Wen discloses a control system, an image system, a plurality of jacks and a driving device. The image system has aiming devices and can capture images above the jacks. The control system exchanges data with the outside world and can store data such as commands, setup information, characteristic parameters and images of vehicles. The control system obtains positioning images from image system of vehicle lifting points and the corresponding jacks. The control system analyzes the positioning images to navigate the driving device, so that the lifting points can be vertically aligned with the jacks. However, Wen does not disclose a device which can be transported on an official vehicle or that can move away from its base under its own power.

U.S. Pat. No. 7,168,906 to Weatherford discloses a set of lift hooks pivotally connected beneath a police vehicle for lifting the rear tires of a suspect vehicle. The lift hooks have lift arms which extend outwardly from flat spring sections which are attached pivotally to front ends of a chassis of the police car. Swivel pads can be positioned on the rigid hooks. However, Weatherford does not disclose a remotely deployable means for immobilizing a vehicle and cannot be easily detached from the police car in emergency situations.

Thus, there remains a need in the art for a system that can safely immobilize a suspect vehicle to aid in preserving officer safety and prevent pursuit interaction fatalities.

### SUMMARY OF THE INVENTION

The immobilizer system is comprised of at least one deployable, remotely actuated lift system. The lift system is transported by a movable frame which can be remotely operated. The movable frame suspends the lift system during transport. However, during the lifting operation, the lift system is positioned squarely on the roadway surface while the movable frame is lifted out of the way. As a result, the movable frame can be of lightweight construction while the lift system can be robust. The lift system supports a universal docking plate which is designed to contact the suspect vehicle and suspend it without damaging it.

In another embodiment, a pair of deployable remotely activated lift systems is employed to increase the weight carrying capacity of the lift system and the resistance to lateral, or “side-to-side” forces created by occupants of a suspect vehicle.

In use, the immobilizer system is deployed and launched on a roadway surface. A remote controller is typically resident in the police vehicle and is used to guide the immobilizer system into position and raise it underneath a suspect vehicle. The controller communicates with the immobilizer units through an extended electrical umbilical cord which supplies power and communication of command signals. In another embodiment, the remote controller communicates control signals by radio and the immobilizer is powered by onboard batteries, which extends its useful range almost indefinitely.

### BRIEF DESCRIPTION OF THE DRAWINGS

In the detailed description of the preferred embodiments presented below, reference is made to the accompanying drawings.

FIG. 1A, shows a preferred embodiment of an immobilizer in a stowed position between a retaining lift and a grill guard.

FIG. 1B, shows an immobilizer in a deployed position in front of a retaining lift.

FIG. 2 shows a preferred embodiment of an immobilizer positioned beneath a suspect vehicle.

FIG. 3 shows a preferred embodiment of a retaining lift.

FIG. 4 shows preferred embodiments of various assemblies of an immobilizer.

FIG. 5 shows a preferred embodiment of a support plate.

FIG. 6 shows a preferred embodiment of a pair of lift assemblies.

FIG. 7 shows a preferred embodiment of a car assembly.

FIG. 8 shows a preferred embodiment of an immobilizer in stowed position in the retaining lift.

FIG. 9A showed a preferred embodiment of an immobilizer in a retracted position.

FIG. 9B shows a preferred embodiment of an immobilizer in a stowed position.

FIG. 9C shows a preferred environment of an immobilize in an extended position.

FIG. 10A shows a preferred embodiment of a control system.

FIG. 10B shows a preferred embodiment of a remote controller.

FIG. 10C shows a preferred embodiment of a local controller.

FIG. 11 shows an alternate preferred embodiment of various sub-assemblies of an immobilizer.

FIG. 12A shows a preferred embodiment of a lift assembly.

FIG. 12B shows a preferred embodiment of a support plate assembly.

FIG. 12C shows a preferred embodiment of a camera in a lift assembly.

FIG. 13 shows an alternate preferred environment of a car assembly.

FIG. 14A shows a pair of cars in retracted positions.

FIG. 14B shows a pair of cars in partially extended positions.

FIG. 14C shows a pair of cars in extended and locked positions.

FIG. 15A shows an alternate preferred embodiment of a control system.

FIG. 15B shows an alternate preferred embodiment of a remote controller.

FIG. 15C shows an alternate preferred embodiment of a local controller.

FIG. 15D shows an alternate preferred embodiment of a local controller.

FIG. 16 shows a preferred embodiment of a method of actuating an immobilizer.

FIG. 17 shows a preferred embodiment of a method of instituting a tank turn.

FIG. 18 shows a preferred embodiment of a method of implementing a forward or reverse movement.

FIG. 19 shows preferred embodiment of a method of instituting a regular turn.

FIG. 20 shows the preferred embodiment of a method of instituting a lift action.

FIG. 21A shows a preferred method of deployment.

FIG. 21B shows a preferred method of stowage.

FIG. 22A shows a preferred method of lifting a suspect vehicle.

FIG. 22B shows a preferred method of lowering a suspect vehicle.

### DETAILED DESCRIPTION OF THE INVENTION

In the description that follows, like parts are marked throughout the specification and figures with the same numerals, respectively. The figures are not necessarily drawn to scale and may be shown in exaggerated or generalized form in the interest of clarity and conciseness. Unless otherwise stated, all tolerances are ±10%.

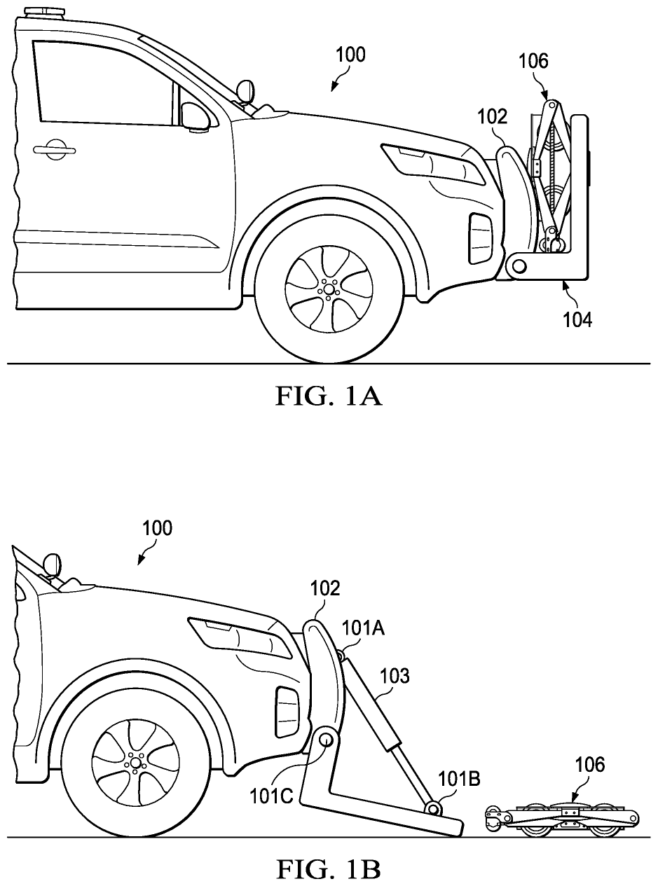

Referring then to FIG. 1A, immobilizer 106 is shown in its stowed position between retaining lift 104 and grill guard 102. Grill guard 102 is rigidly attached to official vehicle 100. Retaining lift 104 is shown in its stowed position. Retaining lift 104 is pivotally attached to grill guard 102 through pivotal connection 101C. In stowed position, immobilizer 106 is prevented from being dislodged either vertically or horizontally from the retaining lift, as will be further described.

Referring to FIG. 1B, immobilizer 106 is shown in its retracted position in front of retaining lift 104. Retaining lift 104 is pivoted downward through the action of linear actuator 103 into its deployed position. Linear actuator 103 is connected to retaining lift 104 and grill guard 102, through pivotal connections 101A and 101B, respectively.

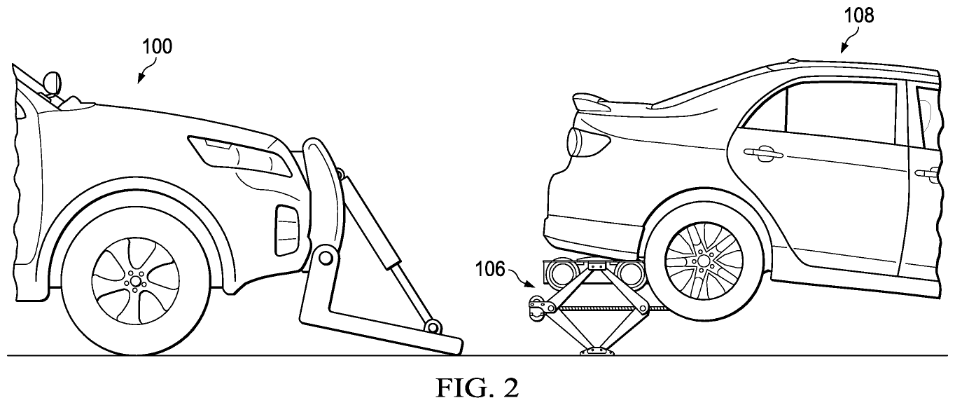

Referring then to FIG. 2, immobilizer 106 is shown positioned beneath suspect vehicle 108. Immobilizer 106 has been moved from its retracted position to its extended position, thereby lifting suspect vehicle 108, and immobilizing it.

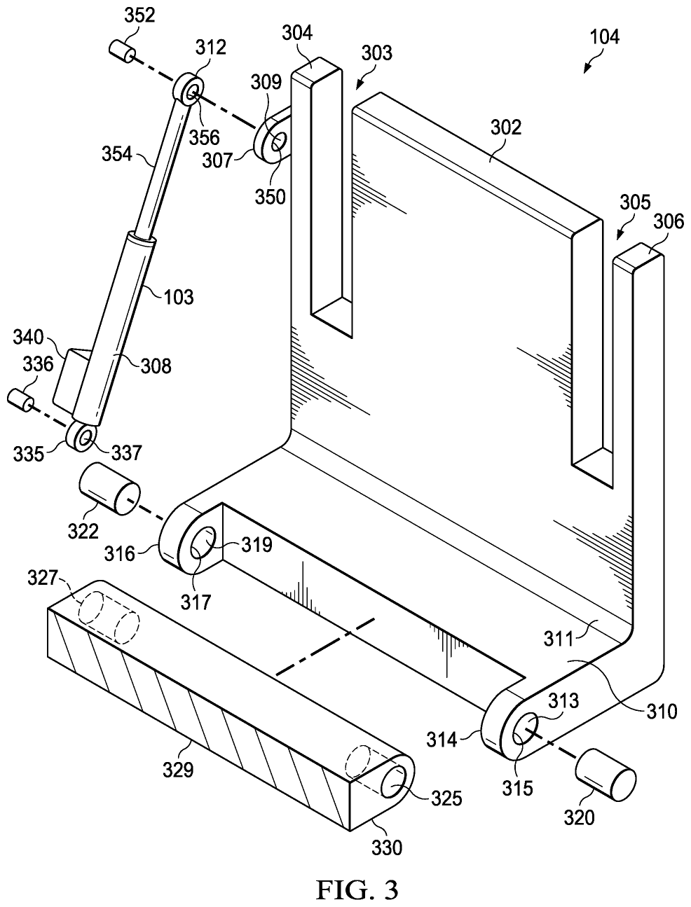

Referring then to FIG. 3, retaining lift 104 will be further described.

Retaining lift 104 is comprised of traction plate 302 rigidly connected to transport plate 310. In a preferred embodiment, traction plate 302 and transport plate 310 are connected at a generally right angle through weldment 311.

Traction plate 302 further comprises access slot 303 and access slot 305. Access slots 303 and 305 are generally parallel and are each sized to accommodate the immobilizer, as will be further described. Traction plate 302 further comprises positioning fork 304, positioned adjacent access slot 303, and positioning fork 306 positioned adjacent access slot 305. The positioning forks accommodate immobilizer 106 and position it for transport, as will be further described.

Transport plate 310 further comprises flange 314 and flange 316. Flange 314 includes hole 315. Hole 315 includes bearing surface 313. Flange 316 includes hole 317. Hole 317 includes bearing surface 319.

Plate support 330 is rigidly connected to grill guard 102 through weldment 329. Plate support 330 further comprises hole 325 and hole 327. Hole 325 and hole 327 are, in a preferred embodiment, coaxial.

Pin 320 is positioned through hole 315 adjacent bearing surface 313 and is fixed in hole 325. Likewise, pin 322 is positioned in hole 317 adjacent bearing surface 319 and is fixed in hole 327. In a preferred embodiment, when the retaining lift is assembled, pin 322 is coaxial with pin 320. The pins allow pivotal motion between the retaining lift and the plate support.

Positioning fork 304 further comprises flange 307. Flange 307 includes hole 350. Hole 350 includes bearing surface 309.

Linear actuator 103 is further comprised of cylinder 308 and rod 354. Rod 354 is telescopically disposed within cylinder 308. Linear actuator 103 further comprises electric drive motor 340. When electric drive motor 340 is actuated, rod 354 may be extended or retracted within cylinder 308, as will be further described.

Rod 354 further comprises flange 312. Flange 312 includes hole 356. Linear actuator 103 further comprises flange 335. Flange 335 includes hole 337.

Pin 352 is positioned through hole 356 and into hole 350 adjacent bearing surface 309 and into pivotal connection 101B. Likewise, pin 336 is positioned through hole 337 and into pivotal connection 101A. Pin 352 allows pivotal motion between linear actuator 103 and the retaining lift. Pin 336 allows pivotal motion between linear actuator 103 and grill guard 102.

In use, when linear actuator 103 is activated, transport plate 310 and traction plate 302 are pivoted about pin 320 and pin 322 from or to a stowed position to or from a deployed position, as will be further described.

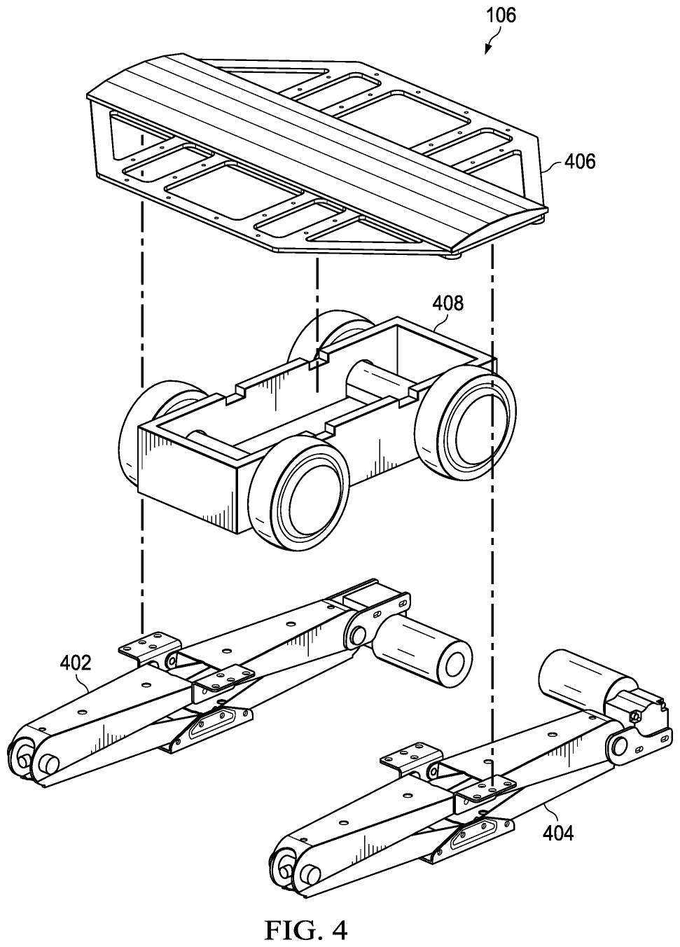

Referring then to FIG. 4, the assemblies of immobilizer 106 will be further described.

Immobilizer 106 further comprises docking plate 406 rigidly connected to lift mechanism 402 and lift mechanism 404. Docking plate 406 is further rigidly connected to car 408, as will be further described.

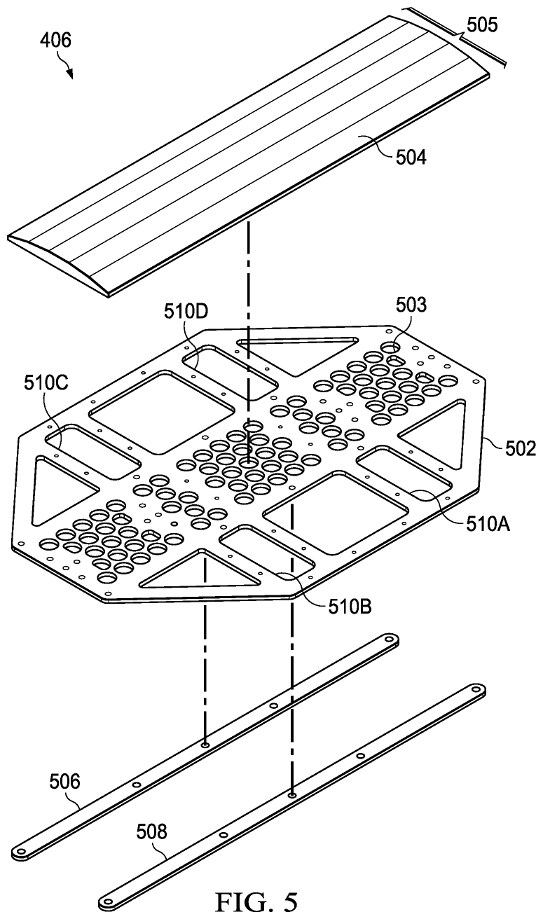

Referring then to FIG. 5, docking plate 406 will be further described.

Docking plate 406 further comprises base plate 502. In a preferred embodiment, base plate 502 is formed from a single sheet of ⅜ inch stainless steel or titanium plate. Base plate 502 further comprises a number of weight reduction holes 503. Base plate 502 further comprises generally rectangular wheel access holes 510A, 510B, 510C, and 510D, as will be further described.

Cushion 504 is fixed to base plate 502 through a suitable industrial adhesive. In a preferred embodiment, cushion 504 is a closed cell neoprene pad approximately 1 inch in thickness. In another embodiment, the pad is manufactured from a deformable polyurethane plastic. Other flexible materials may be used. In a preferred embodiment cushion 504 includes upper arcuate surface 505. In use, the arcuate surface of cushion 504 reduces damage to suspect vehicle 108, when the immobilizer is in use.

Base plate 502 further comprises of latitudinal support beam 506 and latitudinal support beam 508. Each of the latitudinal support beams is rigidly fixed to base plate 502. The lateral support beams offer structural support for base plate 502, when the immobilizer is in use.

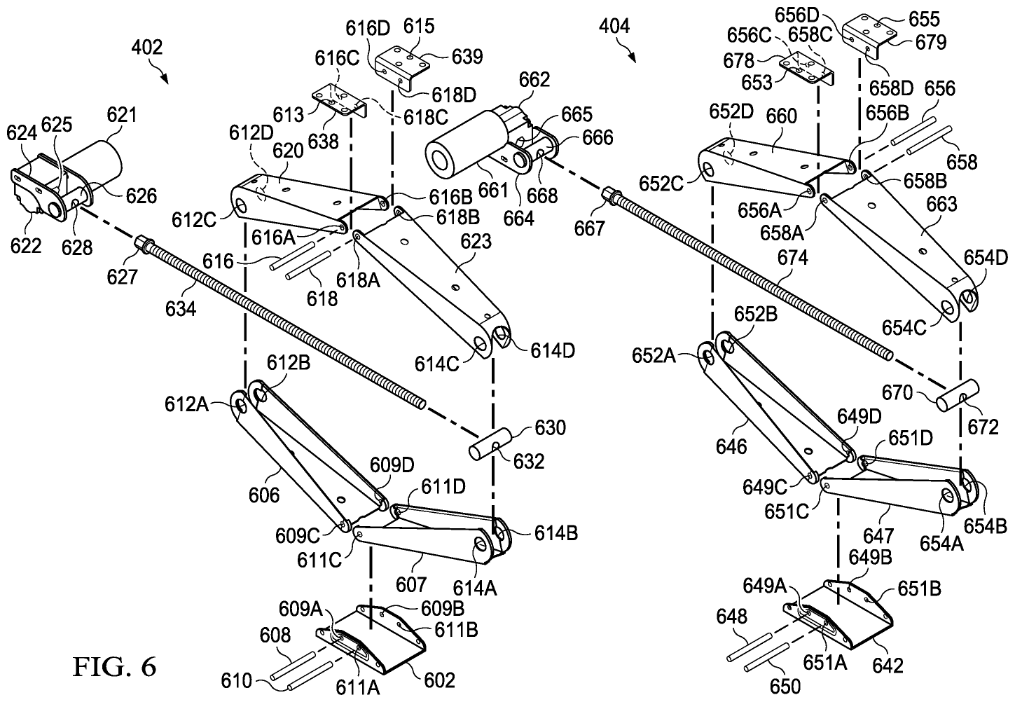

Referring then to FIG. 6, lift mechanism 402 and lift mechanism 404 will be further described. In a preferred embodiment, lift mechanisms 402 and 404 are each Part No. 24210 available from BAL R.V. Products Group of Elkhart, Indiana.

Lift mechanism 402 includes foot bracket 602. Foot bracket 602 is generally a u-shaped steel channel. Foot bracket 602 further comprises pivot hole 609A, pivot hole 609B, pivot hole 611A, and pivot hole 611B. Lift mechanism 402 further comprises opposing lift arms 606 and lift arm 607. Lift arms 606 and 607 are formed of generally trapezoidal u-shaped steel channel. Lift arm 606 includes pivot holes 609C and 609D. Lift arm 606 further comprises receiver hole 612A and 612B. Lift arm 607 further comprises pivot holes 611C and 611D. Lift arm 607 further comprises receiver holes 614A and 614B.

Lift arm 606 is connected to foot bracket 602 by pin 608. Pin 608 proceeds through pivot hole 609A, pivot hole 609C, pivot hole 609D, and pivot hole 609B. Pin 608 allows pivotal movement between lift arm 606 and foot bracket 602.

Lift arm 607 is connected to foot bracket 602 by pin 610. Pin 610 proceeds through pivot hole 611A, pivot hole 611C, pivot hole 611D, and pivot hole 611B. Pin 610 allows pivotal movement between lift arm 607 and foot bracket 602.

Lift mechanism 402 further comprises lift arm 620 and lift arm 623. Lift arms 620 and 623 are formed of generally trapezoidal u-shaped steel channel. Lift arm 620 includes receiver holes 612C and 612D. Lift arm 620 further comprises pivot holes 616A and 616B. Lift arm 623 further comprises receiver holes 614C and 614D. Lift arm 623 further comprises pivot holes 618A and 618B.

Lift arm 623 is connected to lift arm 607 by trunnion 630. Trunnion 630 proceeds through receiver holes 614A, 614C, 614B, and 614D, thereby forming a pivoted connection.

Lift arm 606 is connected to lift arm 620 by trunnion 626. Trunnion 626 proceeds through receiver holes 612A, 612C, 612D, and 612B, thereby forming a pivoted connection.

Trunnion 630 includes left hand threaded hole 632. Trunnion 626 includes right hand threaded hole 628.

Lift mechanism 402 further comprises drive motor 621. Drive motor 621 is operatively connected to gearbox 622. Gearbox 622 is rigidly mounted to trunnion carriage 624. Trunnion 626 is rigidly mounted to trunnion carriage 624. Gearbox 622 includes hex drive socket 625. When motor 621 is activated, it drives gearbox 622 which, in turn, rotates hex drive socket 625.

Lift mechanism 402 further comprises drive screw 634. Drive screw 634 is operatively positioned in threaded hole 632 and threaded hole 628. Drive screw 634 further comprises integrally formed hex head 627. Hex head 627 is rigidly positioned within hex drive socket 625.

As drive screw 634 turns, it moves trunnion 630 and trunnion 626 inwardly toward an inside limit, or outwardly toward an outside limit, depending on the direction of rotation.

Lift mechanism 402 further comprises bracket 638 and bracket 639. Bracket 638 further comprises holes 616C and 618C. Bracket 639 further comprises holes 616D and 618D. Bracket 638 and bracket 639 are pivotally connected to lift arm 620 and lift arm 623 by pins 616 and 618. Pin 616 is positioned through holes 616A, 616C, 616D, and 616B. Pin 618 is positioned through holes 618A, 618C, 618D, and 618B.

Bracket 638 further comprises plurality of holes 613. Bracket 639 further comprises plurality of holes 615. Brackets 638 and 639 are connected to the bottom surface of base plate 502 by permanent fasteners, such as stainless-steel screws, through plurality of holes 613 and plurality of holes 615.

Lift mechanism 404 includes foot bracket 642. Foot bracket 642 is generally a u-shaped steel channel. Foot bracket 642 further comprises pivot hole 649A, pivot hole 649B, pivot hole 651A, and pivot hole 651B. Lift mechanism 402 further comprises opposing lift arms 646 and lift arm 647. Lift arms 646 and 647 are formed of generally trapezoidal u-shaped steel channel. Lift arm 646 includes pivot holes 649C and 649D. Lift arm 646 further comprises receiver hole 652A and 652B. Lift arm 647 further comprises pivot holes 651C and 651D. Lift arm 647 further comprises receiver holes 654A and 654B.

Lift arm 646 is connected to foot bracket 642 by pin 648. Pin 648 proceeds through pivot hole 649A, pivot hole 649C, pivot hole 649D, and pivot hole 649B. Pin 648 allows pivotal movement between lift arm 646 and foot bracket 642.

Lift arm 647 is connected to foot bracket 642 by pin 650. Pin 650 proceeds through pivot hole 651A, pivot hole 651C, pivot hole 651D, and pivot hole 651B. Pin 650 allows pivotal movement between lift arm 647 and foot bracket 642.

Lift mechanism 404 further comprises lift arm 660 and lift arm 663. Lift arms 660 and 663 are formed of generally trapezoidal u-shaped steel channel. Lift arm 660 includes receiver holes 652C and 652D. Lift arm 660 further comprises pivot holes 656A and 656B. Lift arm 663 further comprises receiver holes 654C and 654D. Lift arm 663 further comprises pivot holes 658A and 658B.

Lift arm 663 is connected to lift arm 647 by trunnion 670. Trunnion 670 proceeds through receiver hole 654A, 654C, 654B, and 654D, thereby forming a pivoted connection.

Lift arm 646 is connected to lift arm 660 by trunnion 666. Trunnion 666 proceeds through receiver hole 652A, 652C, 652D, and 652B, thereby forming a pivoted connection.

Trunnion 670 includes left hand threaded hole 672. Trunnion 666 includes right hand threaded hole 668.

Lift mechanism 404 further comprises drive motor 661. Drive motor 661 is operatively connected to gearbox 662. Gearbox 662 is rigidly mounted to trunnion carriage 664. Trunnion 666 is rigidly mounted to trunnion carriage 664. Gearbox 662 includes hex drive socket 665. When motor 661 is activated, it drives gearbox 662 which, in turn, rotates hex drive socket 665.

Lift mechanism 404 further comprises drive screw 674. Drive screw 674 is operatively positioned in threaded hole 672 and threaded hole 668. Drive screw 674 further comprises integrally formed hex head 667. Hex head 667 is rigidly positioned within hex drive socket 665.

Lift mechanism 404 further comprises bracket 678 and bracket 679. Bracket 678 further comprises holes 656C and 658C. Bracket 679 further comprises holes 656D and 658D. Bracket 678 and bracket 679 are pivotally connected to lift arm 660 and lift arm 663 by pins 656 and 658. Pin 656 is positioned through holes 656A, 656C, 656D, and 656B. Pin 658 is positioned through holes 658A, 658C, 658D, and 658B.

Bracket 678 further comprises plurality of hole 653. Bracket 679 further comprises plurality of hole 655. Brackets 638 and 639 are connected to the bottom surface of base plate 502 by permanent fasteners, such as stainless-steel screws, through plurality of hole 653 and plurality of hole 655.

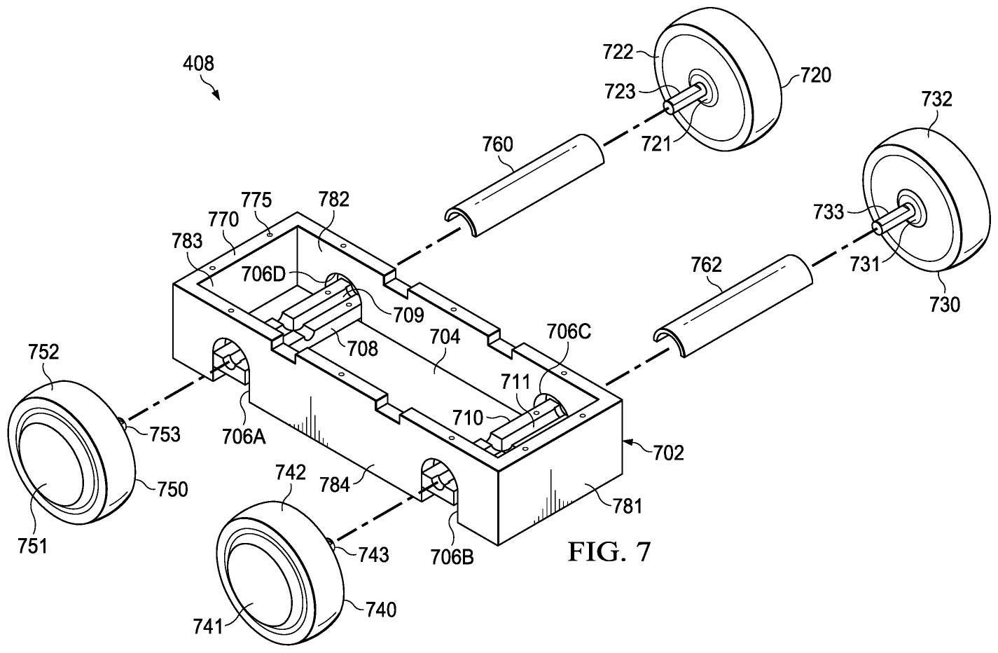

Referring then to FIG. 7, car 408 will be further described.

Car 408 further comprises frame 702. Frame 702 is generally a rectangular box having vertical walls 781, 782, 783 and 784. The walls are preferably manufactured from ½ inch aluminum plate stock joined by suitable weldments. Floor 704 is fixed to the bottom of the walls by suitable fasteners. Floor 704 is preferably likewise a lightweight aluminum plate stock.

Wall 784 includes semicircular wheel wells 706A and 706B. Wall 782 includes semicircular wheel wells 706D and 706C. Wheel well 706A is generally colinear with wheel well 706D. Wheel well 706B is generally colinear with wheel well 706C.

Axle support 708 is rigidly attached to floor 704 and proceeds through wheel well 706A and wheel well 706D. Axle support 708 includes semicircular slot 709, which is latitudinally and centrally disposed within axle support 708. Likewise, axle support 710 is rigidly attached to floor 704 and proceeds through wheel well 706B and wheel well 706C. Axle support 710 includes semicircular slot 711 which is latitudinally and centrally disposed within the axle support 710.

Wheel unit 720 includes motor 721. Motor 721 is pivotally supported by axle 723 and drive wheel 722.

Wheel unit 730 includes motor 731. Motor 731 is pivotally supported by axle 733 and drive wheel 732.

Wheel unit 740 includes motor 741. Motor 741 is pivotally supported by axle 743 and drive wheel 742.

Wheel unit 750 includes motor 751. Motor 751 is pivotally supported by axle 753 and drive wheel 752.

Axle 733 and axle 743 are positioned in slot 711. Axle 733 is generally colinear with axle 743. Axle 723 and axle 753 are positioned in slot 709. Axle 723 is generally collinear with axle 753.

Axle retainer 760 is rigidly attached to axle support 708 and fixes axle 723 and axle 753 rigidly in slot 709.

Axle retainer 762 is rigidly attached to axle support 710 and fixes axle 733 and axle 743 rigidly in slot 711.

Walls 781, 782, 783 and 784 form top support surface 770. Top support surface 770 includes plurality of vertical holes 775. Docking plate 406 is fixed to frame 702 by a plurality of fasteners, such as flat head stainless steel screws, fixed through the plate and into plurality of holes 775.

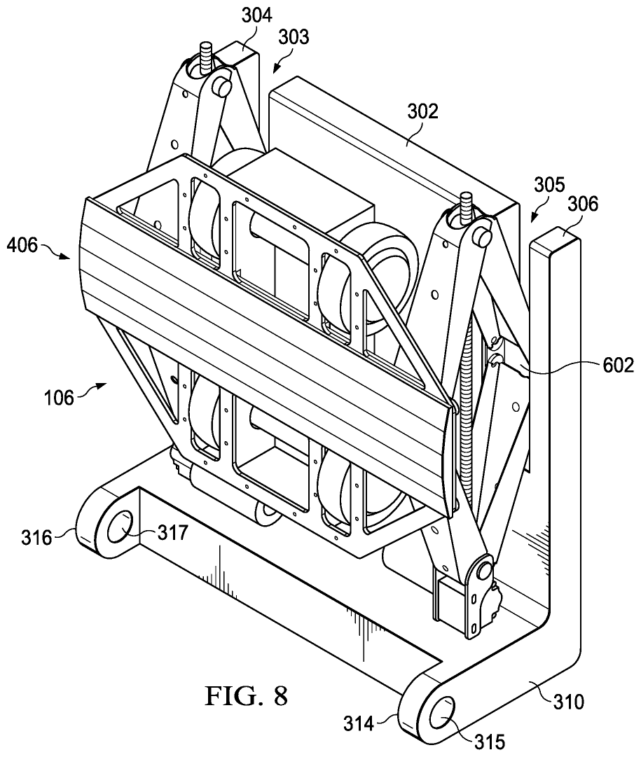

Referring then to FIG. 8, retaining lift 104 will be described in its stowed position.

Foot bracket 602 is shown positioned within access slot 305. Likewise, foot bracket 642 is shown positioned in access slot 303. The foot brackets nest in the access slots between the traction plate and each positioning fork. The docking plate rests adjacent the grill guard. In this position, the weight of the immobilizer retains it within the access slots, during routine activity of the official vehicle.

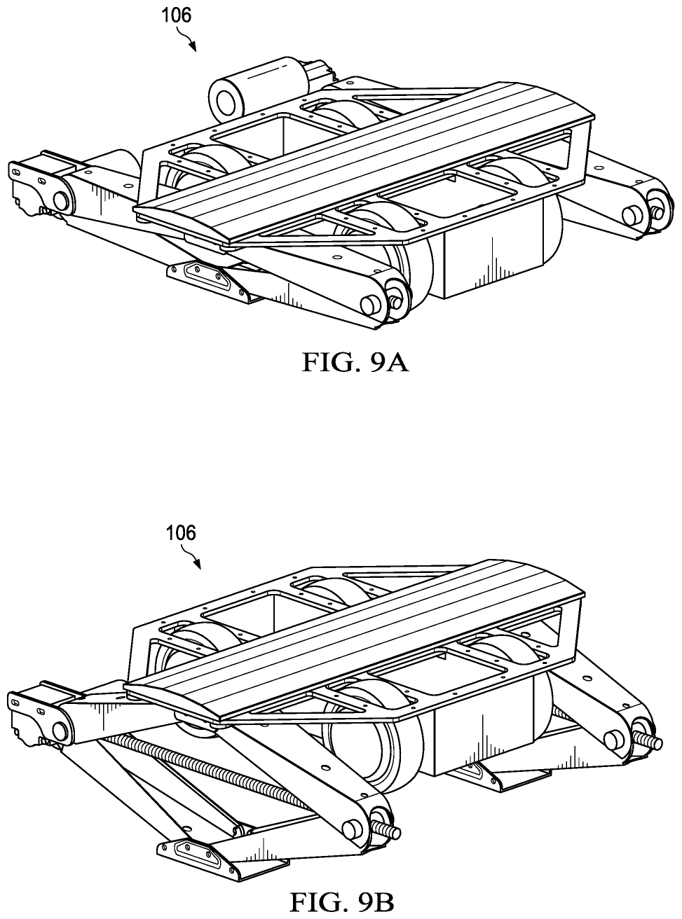

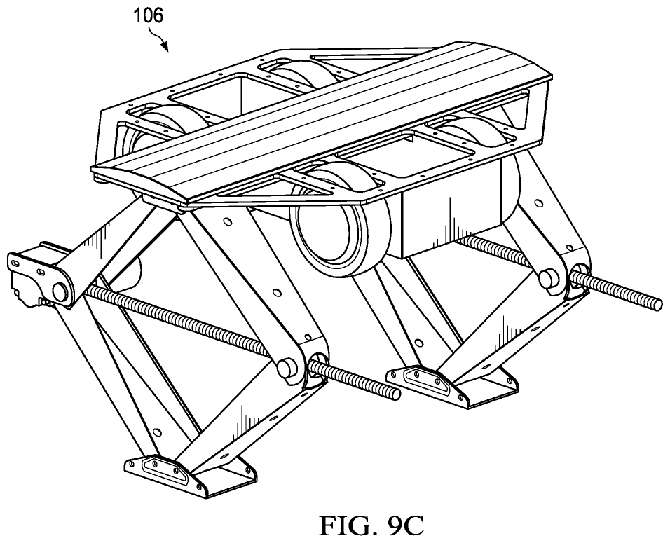

Referring to FIGS. 9A, 9B, and 9C, the various positions of the immobilizer will be further described.

FIG. 9A shows the immobilizer in a “retracted” position. In retracted position, foot bracket 602 resides adjacent brackets 638 and 639. Likewise, foot bracket 642 resides adjacent brackets 678 and 679. Trunnions 630 and 626 are at their maximum limit of travel along drive screw 634. Likewise, trunnions 670 and 666 are at their maximum limits of travel on drive screw 674. Lift arms 606, 607, 620 and 623 are in fully collapsed position. Likewise, lift arms 646, 647, 660, and 663 are in fully collapsed position. Wheel units 750, 740, 720, and 730 are resident in holes 510C, 510B, 510D, and 510A, respectively, and are free to rotate.

Importantly, foot bracket 602 and foot bracket 642 are positioned above ground level, thereby allowing wheels 752, 742, 722 and 732 to move the immobilizer along the ground surface without interference from foot bracket 602 or foot bracket 642.

FIG. 9B shows the immobilizer in a “stowed” position. To arrive at stowed position, motor 621 and motor 661 are activated, thereby advancing drive screw 634 and drive screw 674, respectively. As drive screw 634 is advanced, lift arm 606 approaches lift arm 607 and lift arm 620 approaches lift arm 623, enabled by inward forces from trunnion 630 and trunnion 626. Likewise, lift arm 646 advances toward lift arm 647 and lift arm 660 advances toward lift arm 663, enabled by inward forces resulting from trunnion 666 and trunnion 670. Foot bracket 602 and foot bracket 642 move downward into contact with the roadway surface, thereby lifting car 408 off of the roadway surface and elevating docking plate 406.

FIG. 9C shows the immobilizer in “extended” position. To arrive at extended position, motor 621 and motor 661 are further activated and advance drive screw 634 and drive screw 674, respectively. Trunnion 630 and trunnion 626 have reached their inward limits of travel along drive screw 634. Likewise, trunnion 670 and trunnion 666 have reached their inward limits of travel along drive screw 674. As a result, the lift arms move to their raised positions. In a preferred embodiment, in extended position, docking plate 406 is fixed approximately 18 inches above foot bracket 602 and foot bracket 642, which are positioned on the roadway surface. Importantly, the car assembly remains firmly attached to the support plate and so is suspended above the roadway surface. This is important because the wheel units are not required to support the weight of the suspect vehicle, and so can be of lightweight and fast construction, thereby greatly increasing the speed and agility of the immobilizer without sacrificing great lifting capacity.

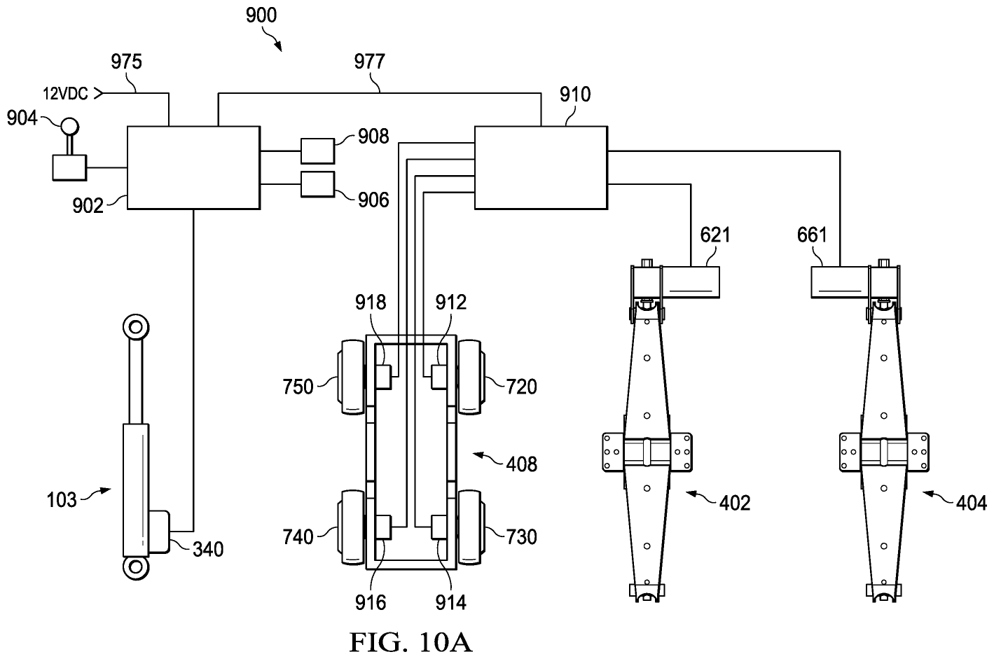

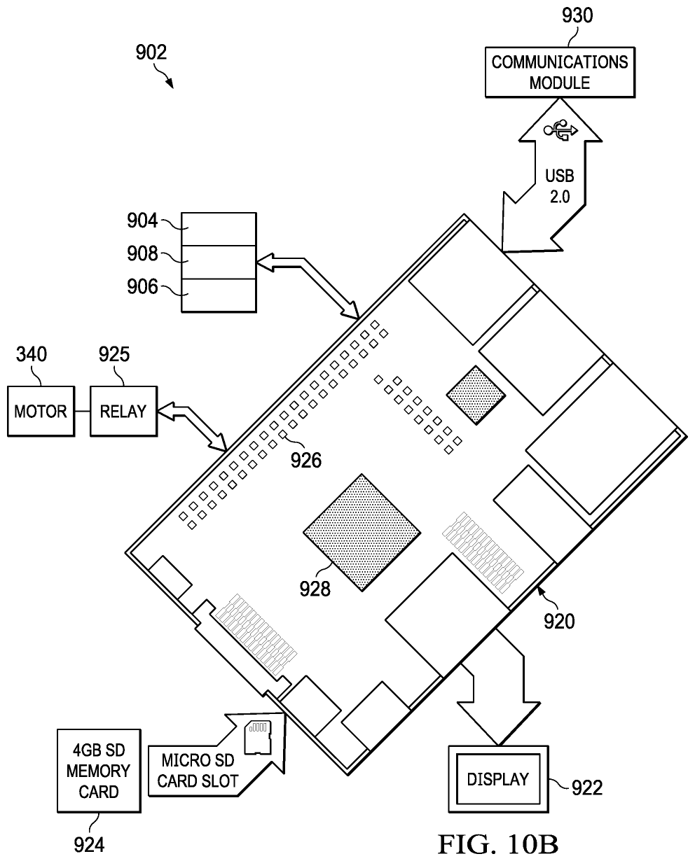

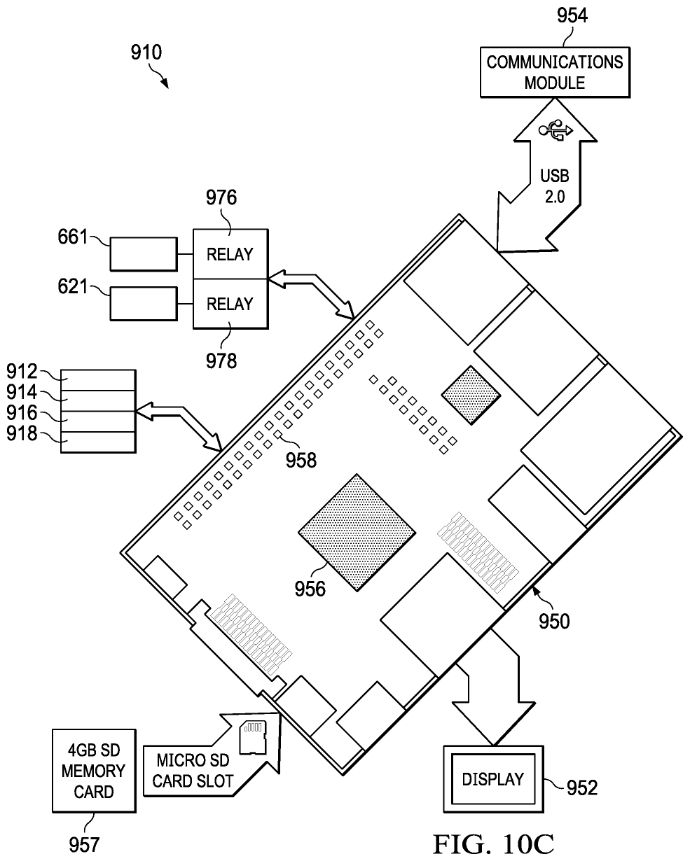

Referring to FIG. 10A, a preferred embodiment of control system 900 for immobilizer 106 will be further described.

Control system 900 is comprised of remote controller 902. In general, remote controller 902 comprises a processor and memory, as will be further described. In a preferred embodiment, remote controller 902 and the other components of the system are powered by 12V DC supply 975 from official vehicle 100. In another embodiment, remote controller 902 is powered by an onboard 12V battery, not shown.

Remote controller 902 is operatively connected to joystick 904. Remote controller 902 is further operatively connected to switch 906 and switch 908. In a preferred embodiment, switch 906 and switch 908 are both implemented in joystick controller 904, as will be further described.

Remote controller 902 is further operatively connected to drive motor 340 of linear actuator 103.

In one preferred embodiment, remote controller 902 is connected to local controller 910 through hardwired umbilical 977. Umbilical 977 supplies power and communications signals to local controller 910, as will be further described.

Local controller 910 is further operatively connected to motor controller 912, motor controller 914, motor controller 916 and motor controller 918. Motor controller 912 is operatively connected to wheel unit 720. Motor controller 914 is operatively connected to wheel unit 730. Motor controller 916 is operatively connected to wheel unit 740. Motor controller 918 is operatively connected to wheel unit 750.

Local controller 910 is further operatively connected to motor 621 of lift mechanism 402. Local controller 910 is further operatively connected to motor 661 of lift mechanism 404.

Referring to FIG. 10B remote controller 902 will be further described.

Remote controller 902 further comprises controller board 920. In a preferred embodiment, remote controller 902 is a dedicated master Arduino Uno available from Arduino, LLC of Somerville, Massachusetts.

Controller board 920 is operatively connected to joystick 904, switch 906 and switch 908 through onboard connectors 926. In a preferred embodiment, joystick 904 and switches 906 and 908 are incorporated into a DFR00008 input shield available from DFRobot Corporation of Shanghai, China. In another embodiment, switches 906 and 908 are 3-position rocker switches. Likewise, controller board 920 is connected to relay 925, through onboard connectors 926. Relay 925 is connected to motor 340. In a preferred embodiment, relay 925 is part no. VUPN5949 available from Vetco Electronic of Bellevue, Washington. Controller board 920 further comprises processor 928. Processor 928 draws operating instructions from memory card 924, resident on controller board 920. Controller board 920 further supports display 922 and communications module 930. Display 922 is, preferably, is preferably, part no. uOLED-128-G2 by 4D Systems of Minchinbury, New South Wales, Australia. In one embodiment, communications module 930 is FIT0798 available from DFRobot Corporation. In yet another embodiment, communications module 930 is ESP8266 available from Seeed Technology Co., Ltd. of Shenzhen, China.

In use, processor 928 receives input from joystick 904, switch 906 and switch 908. Joystick 904 provides input for speed and direction for wheel units 720, 730, 740 and 750, as will be further described. Switch 906 provides inputs for activation of motor 621 and motor 661, as will be further described. Switch 908 provides input for activation of motor 340, as will be further described. Display 922 provides visual indicators of the status of the various components of the system, video feedback, and positional feedback from the immobilizer, as will be further described.

Referring to FIG. 10C, local controller 910 will be further described.

Local controller 910 further comprises controller board 950. In a preferred embodiment, local controller 910 is a dedicated Arduino Uno available from Arduino, LLC, as will be further described.

Motor controllers 912, 914, 916 and 918 are operatively connected to controller board 950 through onboard connectors 958. In a preferred embodiment, motor controllers 912, 914, 916 and 918 are, 400 W PWM DC Electric Motor Speed Controller available from RioRand. Likewise, controller board 950 is connected to relays 976 and 978 through onboard connectors 958. Relays 976 and 978 are connected to motors 661 and 621, respectively, and supply them with sufficient current for operation from the 12V DC source. Controller board 950 further comprises processor 956. Processor 956 draws operating instructions from memory card 957, resident on controller board 950. Controller board 950 further supports display 952 and communications module 954. Display 952 is preferably part no. uOLED-128-G2 available from 4D Systems.

In one embodiment, communications between controller board 920 and controller board 950 are provided through a ribbon cable connecting pins A4, A5, and ground on each control board and using a serial peripheral interface (SPI) and synchronous serial communication protocol.

In an alternate embodiment, processor 956 is operatively connected to communications module 954. Communications module 954 is preferably a ESP8266 available from Seeed Technology. In this embodiment, instructions and status signals are communicated through the communications module as an alternative to communicating through the umbilical.

In use, processor 956 receives inputs from joystick 904, switch 906 and switch 908 as relayed by processor 928 through the umbilical or the communications modules. Joystick 904 provides inputs for motor controllers 912, 914, 916 and 918. Switch 906 provides inputs for relays 976 and 978. Display 922 provides visual indicators of the status of the various components of the system and video feedback, as will be further described.

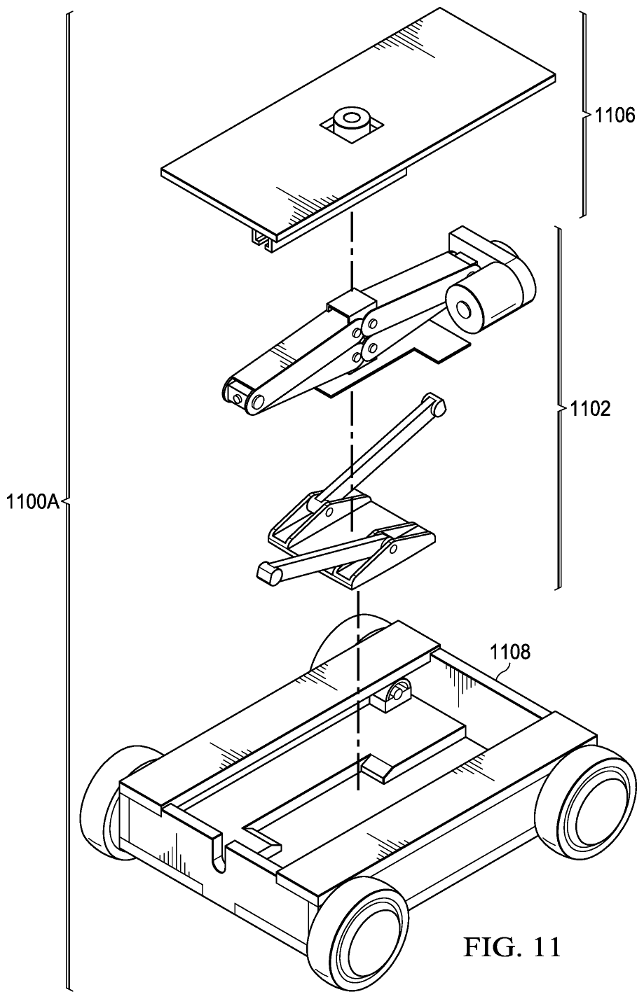

Referring to FIG. 11, an alternate embodiment immobilizer 1100A will be further described. In this embodiment, the system comprises two identical immobilizers. In use, each immobilizer is positioned beneath a separate lift point of the suspect vehicle to provide a secure suspension. A single immobilizer will be described here in detail as an example of both.

Immobilizer 1100A is comprised car assembly 1108, lift assembly 1102, and docking assembly 1106.

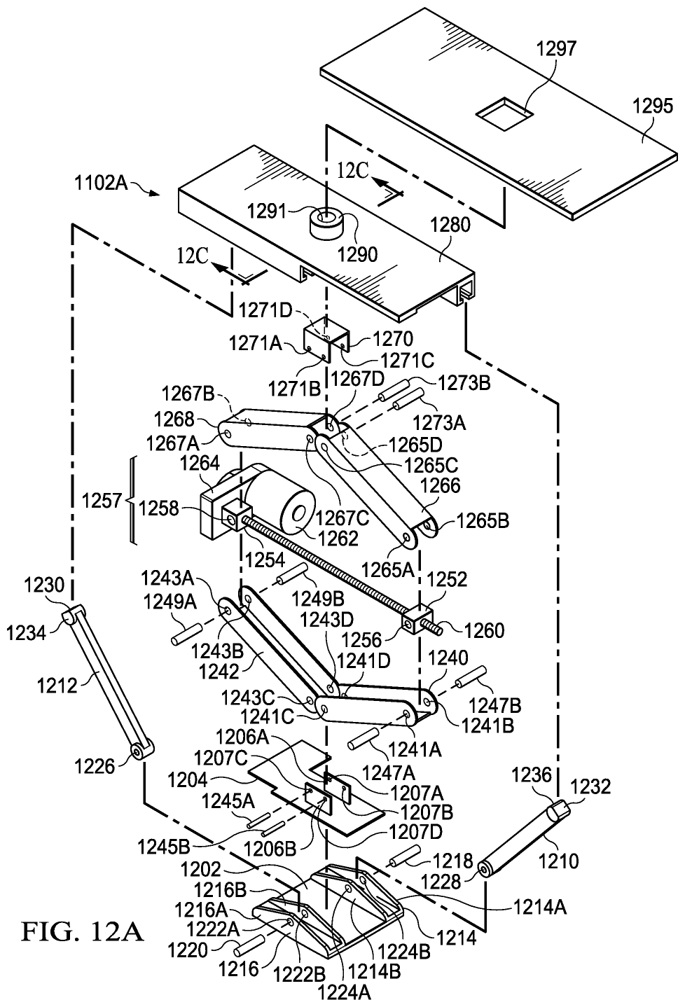

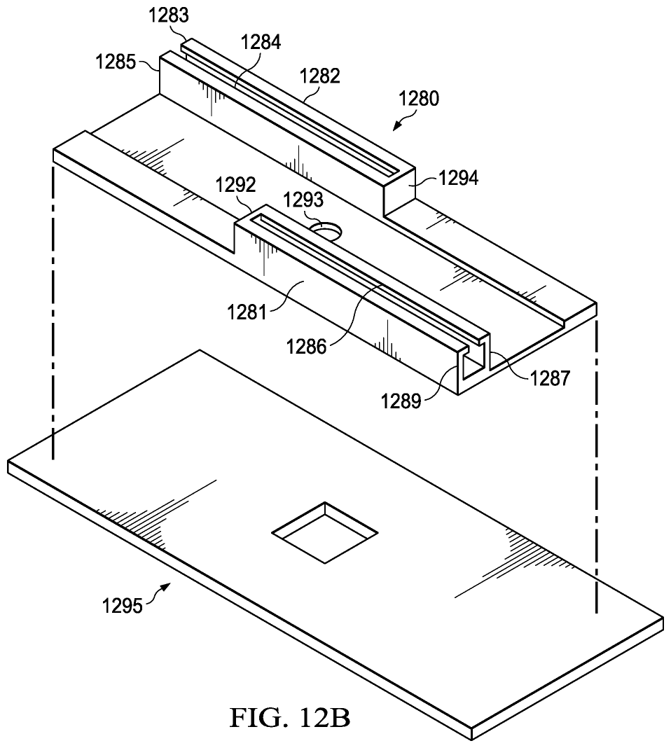

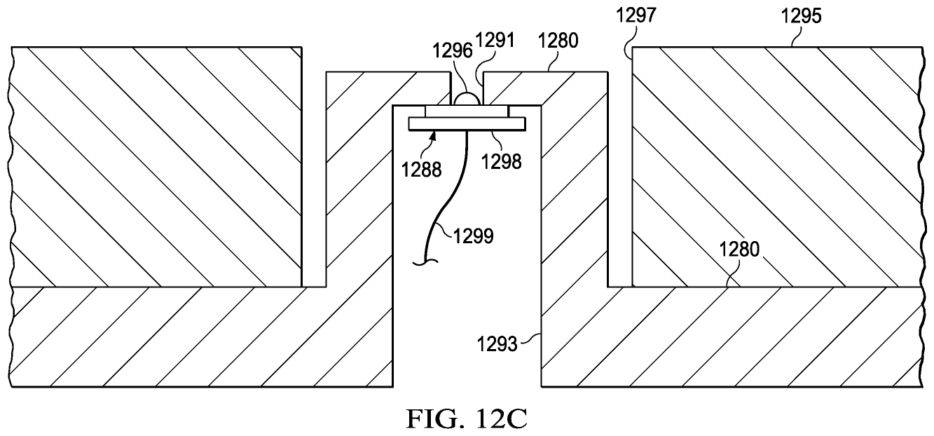

Referring then to FIG. 12A, lift assembly 1102A will be further described.

Lift assembly 1102A comprises foot bracket 1202. Foot bracket 1202 includes lock bracket 1216 and lock bracket 1214. The lock brackets are generally u-shaped channels positioned at opposing sides of the foot bracket and are arranged generally parallel to each other. Lock bracket 1214 is further comprised of opposing flanges 1214A and 1214B. Flanges 1214A and 1214B include holes 1224A and 1224B, preferably holes 1224A and 1224B are colinear. Lock bracket 1216 is further comprised of opposing flanges 1216A and 1216B. Flanges 1216A and 1216B include holes 1222A and 1222B, preferably, holes 1222A and 1222B are colinear. In a preferred embodiment, foot bracket 1202, lock bracket 1214 and lock bracket 1216 are integrally formed from ⅜ inch stainless steel plate, and suitable weldments.

Lift assembly 1102A is further comprised of lock bar 1210 and lock bar 1212. Lock bar 1210 is generally a rectangular extrusion, preferably manufactured from a hardened steel alloy. Lock bar 1210 includes hole 1228. Lock bar 1210 further comprises cylindrical guide 1236. Cylindrical guide 1236 is arranged transverse to the lock bar and includes flat surface 1232. Preferably, flat surface 1232 is generally perpendicular to the long axis of lock bar 1210. Lock bar 1212 is generally a rectangular protrusion manufactured from a hardened steel alloy. Lock bar 1212 includes hole 1226. Lock bar 1212 further comprises cylindrical guide 1234. Cylindrical guide 1234 is arranged transverse to the lock bar and includes flat surface 1230. Preferably flat surface 1230 is generally perpendicular to the long axis of lock bar 1212.

Lock bar 1210 is connected to lock bracket 1214 by pin 1218 proceeding through hole 1224A, hole 1228, and hole 1224B, thereby forming a pivotal connection.

Lock bar 1212 is pivotally connected to lock bracket 1216 by pin 1220 proceeding through hole 1222A, hole 1226, and hole 1222B, thereby forming a pivotal connection.

Lift assembly 1102 further comprises baseplate 1204. Base plate 1204 is formed of ⅛ inch stainless steel plate and forms a platform for various electronic components and batteries of the immobilizer, as will be further described. Base plate 1204 further includes support flange 1206A and support flange 1206B. The support flanges are centrally positioned on the base plate, are vertical, and are arranged generally parallel to each other. Preferably baseplate 1204, support flange 1206A and support flange 1206B are integrally formed of a stainless-steel plate material and are fixed to the base plate by suitable weldments. Support flange 1206A includes holes 1207A and 1207B. Support flange 1206B includes holes 1207C and 1207D. Hole 1207A is generally collinear with hole 1207C. Hole 1207B is generally collinear with hole 1207D.

Base plate 1204 is fixed to foot bracket 1202 preferably by spot welding.

Lift assembly 1102 further comprised of lift arm 1240 and lift arm 1242. Lift arm 1240 and lift arm 1242 are generally u-shaped steel channels. Lift arm 1240 further includes receiver holes 1241A, 1241B, 1241C and 1241D. Receiver holes 1241A and 1241B are generally colinear. Receiver holes 1241C and 1241D are generally colinear. Lift arm 1242 further comprises receiver holes 1243A, 1243B, 1243C and 1243D. Receiver holes 1243A and 1243B are generally colinear. Receiver holes 1243C and 1243D are generally colinear.

Lift arm 1240 is pivotally connected to base plate 1204 by pin 1245B proceeding through holes 1207D, 1241C, 1241D and 1207B. Lift arm 1242 is pivotally connected to baseplate 1204 by pin 1245A proceeding through holes 1207C, 1243C, 1243D and 1207A.

Lift assembly 1102A is further comprised of drive assembly 1257. In a preferred embodiment, drive assembly 1257 is an electric scissor lift jack, such as part no. JSQJD-01 available from Anbull of Shenzhen, China. Drive assembly 1257 is comprised of motor 1262 operatively connected to gearbox 1264. Gearbox 1264 is rigidly connected to trunnion 1254 and operatively connected to drive screw 1260. Drive screw 1260 is operatively engaged with trunnion 1252. In operation, motor 1262 drives gearbox 1264 which in turn rotates drive screw 1260 in one of two opposite directions. As drive screw 1260 is rotated, the trunnions either move toward each other to an inside limit, or away from each other toward an outside limit, depending on the direction of rotation of the drive screw, as will be further described.

Trunnion 1252 further includes pivot hole 1256. Trunnion 1254 further includes pivot hole 1258.

Lift assembly 1102 further comprises lift arm 1266 and lift arm 1268. Lift arm 1266 and lift arm 1268 preferably are formed from steel channel. Lift arm 1266 includes colinear receiver holes 1265A and 1265B. Likewise, lift arm 1266 further comprises colinear receiver holes 1265C and 1265D. Lift arm 1268 further comprises colinear receiver holes 1267A and 1267B. Likewise, lift arm 1268 further comprises colinear receiver holes 1267C and 1267D.

Lift arm 1242 and lift arm 1268 are pivotally fixed to trunnion 1254 by pin 1249A proceeding through receiver hole 1243A, receiver hole 1267A and into pivot hole 1258. Lift arm 1268 is further pivotally fixed to lift arm 1242 by pin 1249B proceeding through receiver hole 1243B, receiver hole 1267B and into pivot hole 1258.

Lift arm 1266 is pivotally fixed to lift arm 1240 by pin 1247A proceeding through receiver hole 1241A, receiver hole 1265A, and into pivot hole 1256. Likewise, lift arm 1266 is pivotally fixed to lift arm 1240 by pin 1247B proceeding through receiver hole 1241B, receiver hole 1265B, and into pivot hole 1256.

Lift assembly 1102 further comprises bracket 1270. Bracket 1270 is generally a u-shaped channel manufactured from stainless steel plate. Bracket 1270 includes holes 1271A, 1271B, 1271C, and 1271D. Hole 1271A is generally colinear with hole 1271D. Hole 1271B is generally colinear with hole 1271C. Lift arm 1268 is pivotally fixed to bracket 1270 by pin 1273B proceeding through hole 1271D, hole 1267D, hole 1271A and hole 1267C. Likewise, lift arm 1266 is pivotally connected to bracket 1270 by pin 1273A proceeding through receiver hole 1265D, hole 1271C, hole 1271B and receiver hole 1265C.

Bracket 1270 is rigidly fixed to lock plate 1280, preferably by a suitable weldment.

Referring then to FIGS. 12A and 12B, lock plate 1280 includes centering cylinder 1290. Centering cylinder 1290 includes cavity 1293 and axial hole 1291. Cavity 1293 proceeds through lock plate 1280 and will be further described. In a preferred embodiment, the lock plate and centering cylinder are integrally formed of a rigid steel alloy, plate stock or a machined casting. In an alternate embodiment, the lock plate and centering cylinder are formed of a lightweight aluminum alloy, which is malleable, to protect damage to the suspect vehicle when in use.

Lock plate 1280 further comprised retainer track 1281 and retainer track 1282. Retainer track 1281 includes longitudinal flange 1287 and longitudinal flange 1289. Longitudinal flange 1287 and longitudinal 1289 each form opposing L-shaped vertical walls which bound slot 1286. Slot 1286 is terminated by limit stop 1292. Lock bar 1210, travels within slot 1286, as will be further described.

Likewise, retainer track 1282 includes longitudinal flange 1283 and longitudinal flange 1285. Longitudinal flange 1283 and longitudinal flange 1285 form opposing L-shaped vertical walls which bound slot 1284. Longitudinal flange 1283, longitudinal flange 1285 and slot 1284 is terminated by limit stop 1294. Lock bar 1212 travels within slot 1284, as will be further described.

Contact plate 1295 is generally a flat pad, preferably formed of a semi-pliable polyurethane. Contact plate 1295 further comprises access hole 1297. During assembly, lock plate 1280 is fixed to contact plate 1295 by suitable industrial adhesive with centering cylinder 1290 proceeding through access hole 1297. The centering cylinder is important because it provides secure contact with a lift point of the suspect vehicle. The access hole and contact plate aid in aligning the centering cylinder on the lift point without damaging the suspect vehicle.

Referring then to FIG. 12C, centering cylinder 1290 includes cavity 1293 and axial hole 1291. Camera assembly 1288 is positioned in cavity 1293, in position to view vertically upward through axial hole 1291. A protective lens is envisioned. The camera assembly is fixed in place with a suitable industrial adhesive. Camera assembly 1288 is comprised of camera module 1296 and camera shield 1298. Preferably, camera module 1296 is a video camera having at least 30 fps and good low-light sensitivity, such as part no. MT9M001 available from Arducam of Jiangsu, China. Likewise, camera shield 1298 is preferably Arducam-F V2 camera module shield available from Arducam.

Camera module 1296 transmits a video signal to the controller for display, as will be further described. In a preferred embodiment, the camera shield is connected to the controller through ribbon cable 1299 connecting pins CS, MOSI, MISO, SCLK on the appropriate control board.

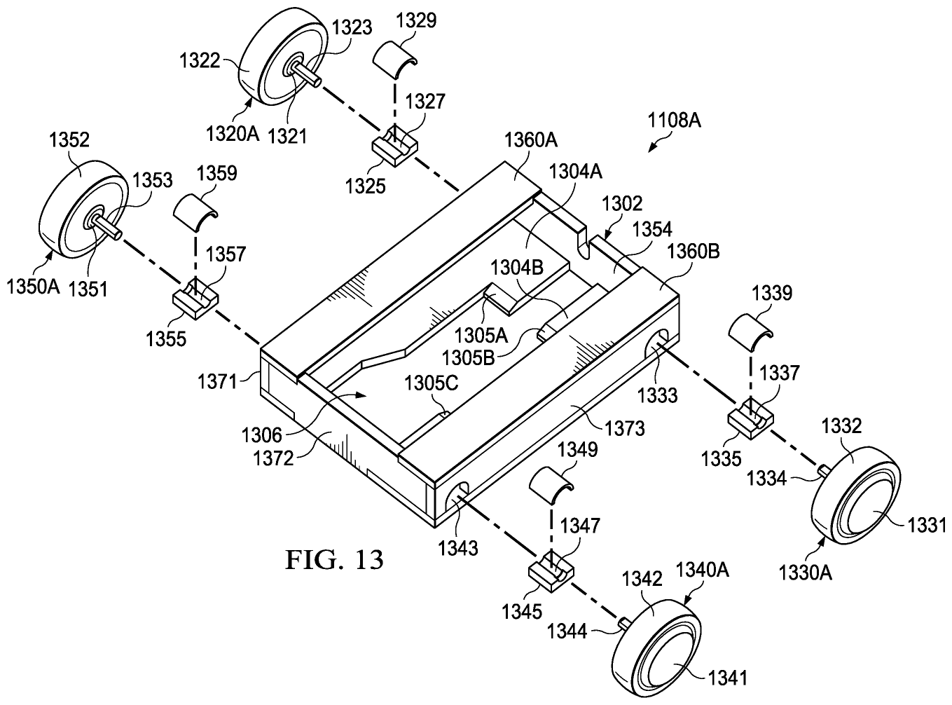

Referring to FIG. 13, car assembly 1108A will be further described.

Car assembly 1108A comprises frame 1302. Frame 1302 is generally a rectangular box formed from vertical walls 1354, 1371, 1372 and 1373. Vertical walls 1371, 1372 and 1354 support floor panel 1304A and top panel 1360A. Vertical walls 1354, 1373 and 1372 support floor panel 1304B and top panel 1360B. The walls, floor panels and top panels are, preferably manufactured from a suitable aluminum alloy, preferably ¼ inch thick, fixed by welding.

Floor panels 1304A and 1304B form angular access hole 1306. Angular access hole 1306 accommodates lift assembly 1102, as will be further described. Floor panels 1304A and 1304B include sloping guide surfaces 1305A, 1305B and 1305C, respectively. The angled guide surfaces engage the lift arms and aid in centering the lift assembly within the frame as it is being retracted.

Car assembly 1108A is further comprised of wheel unit 1320A. Wheel unit 1320A in a preferred embodiment, is an AMK 36V 200 W 6.5″ brushless hub motor kit available from L-Faster of Zhejiang, China. Wheel unit 1320A further comprises centrally disposed motor 1321. Motor 1321 is operatively connected to axle 1323 and drive wheel 1322. Axle 1323 is rigidly connected to axle support 1325 by slot 1327. Axle 1323 is retained by axle retainer 1329. Axle support 1325 and axle retainer 1329, when assembled are fixed to floor panel 1304A through a wheel well in wall 1371, not shown.

Car assembly 1108A is further comprised of wheel unit 1330A. Wheel unit 1330A in a preferred embodiment, is an AMK 36V 200 W 6.5″ brushless hub motor kit. Wheel unit 1330A further comprises centrally disposed motor 1331. Motor 1331 is operatively connected to axle 1334 and drive wheel 1332. Axle 1334 is rigidly connected to axle support 1335 by slot 1337. Axle 1334 is retained by axle retainer 1339. Axle support 1335 and axle retainer 1339, when assembled are fixed to floor panel 1304B through wheel well 1333 in wall 1373.

Car assembly 1108A is further comprised of wheel unit 1340A. Wheel unit 1340A in a preferred embodiment, is an AMK 36V 200 W 6.5″ brushless hub motor kit. Wheel unit 1340A further comprises centrally disposed motor 1341. Motor 1341 is operatively connected to axle 1344 and drive wheel 1342. Axle 1344 is rigidly connected to axle support 1345 by slot 1347. Axle 1344 is retained by axle retainer 1349. Axle support 1345 and axle retainer 1349, when assembled, are fixed to floor panel 1304B through wheel well 1343 in wall 1373.

Car assembly 1108A further comprised of wheel unit 1350A. Wheel unit 1350A in a preferred embodiment, is AMK 36V 200 W 6.5″ brushless hub motor kit. Wheel unit 1350A further comprises centrally disposed motor 1351. Motor 1351 is operatively connected to axle 1353 and drive wheel 1352. Axle 1353 is rigidly connected to axle support 1355 by slot 1357. Axle 1353 is retained by axle retainer 1359. Axle support 1355 and axle retainer 1359, when assembled, are fixed to floor panel 1304A through a wheel well in wall 1372, not shown.

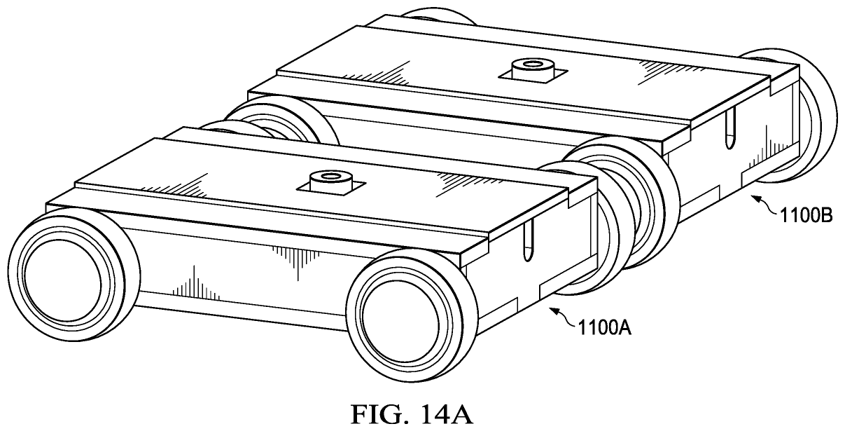

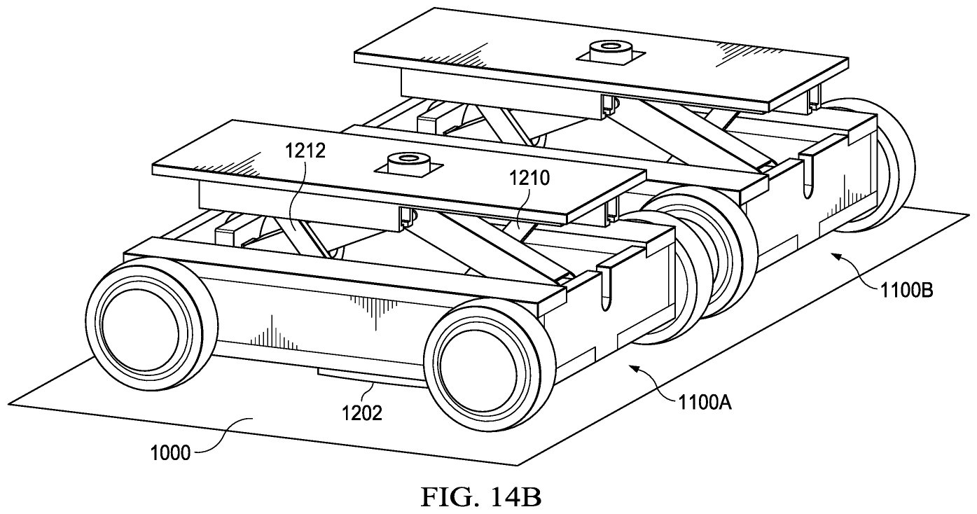

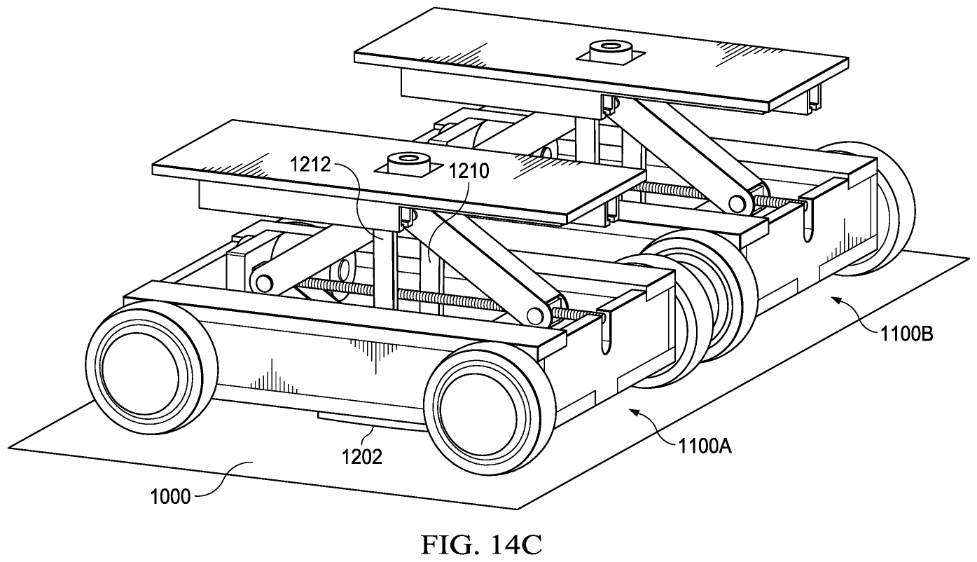

Referring to FIG. 14A, positions of immobilizers 1100A and 1100B will be further described.

In FIG. 14A immobilizers 1100A and 1100B are shown in “retracted position”, as will be further described. In this embodiment, the immobilizers are preferably deployed in pairs and may be positioned under opposing sides of a front or rear axle of the suspect vehicle. Importantly, each lift unit is in retracted position and is nested within its corresponding access hole. Hence, the lift assemblies are not in contact with the roadway surface and each immobilizer is free to move under the power of its wheel units.

As shown in FIG. 14A, in retracted position contact plate 1295 rests, on frame 1302 thereby holding the lift assembly and foot bracket 1202 upwardly in access hole 1306.

As shown in FIG. 14A in retracted position, trunnion 1252 and trunnion 1254 are in their outside limit positions.

Referring to FIG. 14B immobilizers 1100A and 1100B are shown in “partially extended position.” Considering FIG. 12A and immobilizer 1100A as an example, in partially extended position, motor 1262 has been activated to rotate drive screw 1260 to move trunnion 1252 and trunnion 1254 inwardly. As trunnions 1252 and 1254 move inwardly, lift arms 1240, 1242, 1266 and 1268 collapse inwardly thereby moving foot bracket 1202 downwardly and into contact with roadway surface 1000. Bracket 1270, lock plate 1280 and contact plate 1295 move upwardly and out of access hole 1306, after foot bracket 1202 contacts the roadway surface. Lock bar 1212 and lock bar 1210 slide toward each other, in slots 1284 and 1286, respectively, while pivoting with respect to foot bracket 1202.

Referring to FIG. 14C, immobilizer 1100A and immobilizer 1100B are shown in “extended and locked position.” Foot bracket 1202 is shown in contact with roadway surface 1000. In extended and locked position, motor 1262 has been activated to rotate drive screw 1260, thereby moving trunnion 1252 and trunnion 1254 inwardly to their inside limit positions. Lock bar 1212 and lock bar 1210 have pivoted with respect to foot bracket 1202, to vertical positions thereby bringing flat surface 1230 and flat surface 1232 into contact with retainer track 1281 and retainer track 1282, respectively. In their vertical positions, the lock bars are important because they form the primary load bearing members of the structure of the lift assembly and greatly increase lateral support to the suspect vehicle, thereby resisting lateral “shaking” loads from within the suspect vehicle. As main load bearing structures, they are also capable of supporting far more weight than the lift arms alone, thereby greatly increasing the vertical weight bearing capacity of each immobilizer.

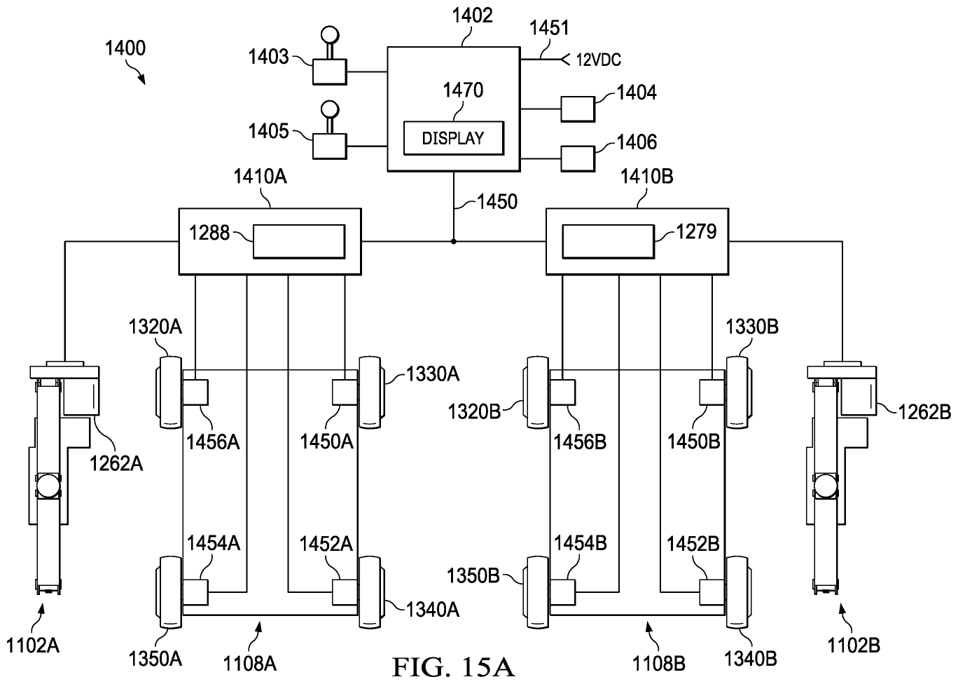

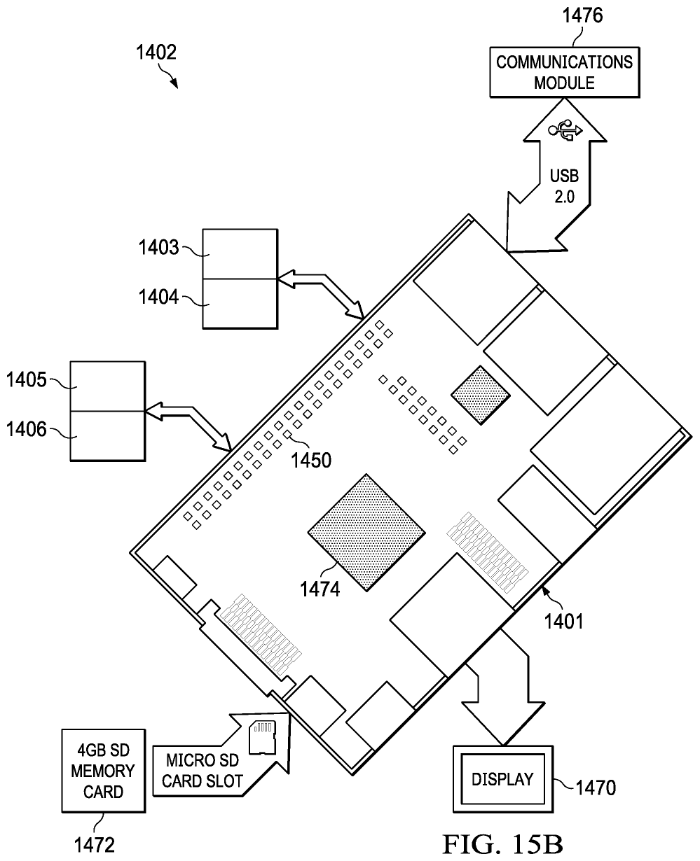

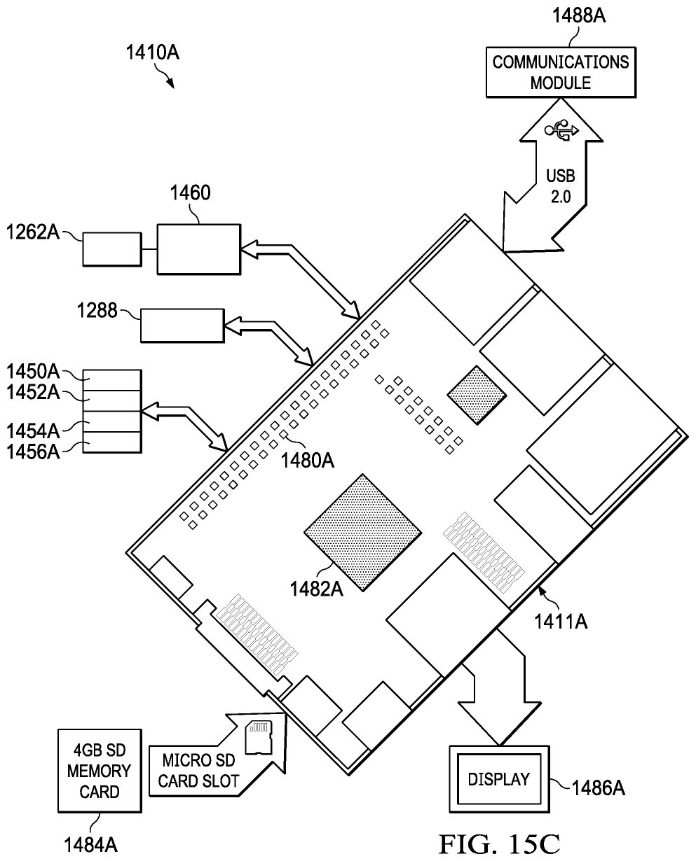

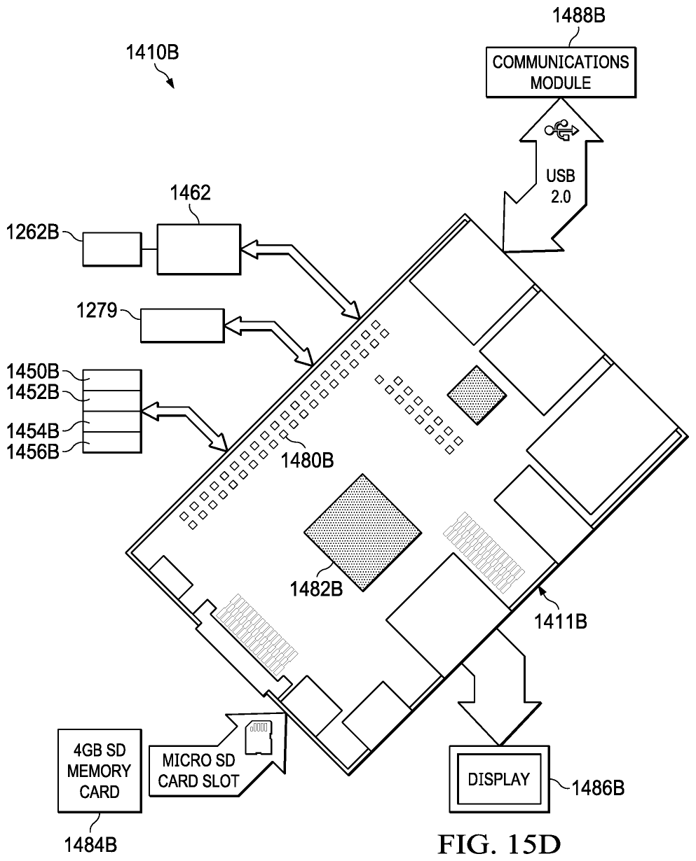

Refer to FIG. 15A, remote control system 1400 will be further described. Remote control system 1400 is further comprised of remote controller 1402. Remote controller 1402 generally comprises a processor, memory, and display, as will be further described. Remote controller draws power from 12V DC connection 1451, connected to the power system of official vehicle 100. Alternatively, 12V DC power may be drawn from a separate storage battery (not shown).

Remote controller 1402 is operatively connected to rocker switch 1404 and rocker switch 1406. In operation, rocker switch 1404 advances or retracts lift assembly 1102A by activating motor 1262A. Likewise, rocker switch 1406 in operation, extends or retracts lift assembly 1102B by activating motor 1262B.

Remote controller 1402 further comprises joystick 1403, and joystick 1405. In operation, joystick 1403 controls the motion of car assembly 1108A, through activation of wheel units 1320A, 1330A, 1340A and 1350A, as will be further described. In operation, joystick 1405 controls the motion of car assembly 1108B through activation of wheel units 1320B, 1330B, 1340B and 1350B, as will be further described.

Remote control system 1400 further comprises local controller 1410A and local controller 1410B. Generally, local controllers 1410A and 1410B each include a processor and a memory, as will be further described.

Local controller 1410A is operatively connected to motor 1262A which raises and lowers its onboard lift assembly. Local controller 1410B is operatively connected to motor 1262B which raises and lowers its onboard lift assembly.

Local controller 1410A is further operatively connected to motor controllers 1450A, 1452A, 1454A and 1456A. Motor controller 1450A is operatively connected to and controls motor 1331 of wheel unit 1330A. Motor controller 1452A is operatively connected to and controls motor 1341 of wheel unit 1340A. Motor controller 1454A is operatively connected to and controls motor 1351 of wheel unit 1350A. Motor controller 1456A is operatively connected to and controls motor 1321 of wheel unit 1320A.

Local controller 1410B is further operatively connected to motor controllers 1450B, 1452B, 1454B and 1456B. Motor controller 1450B is operatively connected to and controls motor 1331 of wheel unit 1330B. Motor controller 1452B is operatively connected to and controls motor 1341 of wheel unit 1340B. Motor controller 1454B is operatively connected to and controls motor 1351 of wheel unit 1350B. Motor controller 1456B is operatively connected to and controls motor 1321 of wheel unit 1320B.

Remote controller 1402 is preferably connected to local controller 1410A and local controller 1410B through umbilical 1450. Umbilical 1450 includes two 12V DC power cables and two 3-wire ribbon cables. The 3-wire ribbon cables connect the A4, A5, and ground pins in the controller board of remote controller 1402 to the A4, A5, and ground pins in the controller board of local controller 1410A, and pins A6, A7, and ground of remote controller 1402 to the A4, A5, and ground pins of local controller 1410B, as will be further described. In a preferred embodiment, the umbilical also includes the 4-wire ribbon cables required which connect the camera assemblies of each immobilizer to remote controller 1402, as will be further described. In operation, remote controller 1402 communicates instructions from the joysticks and switches to local controllers 1410A and 1410B and receives status updates and video signals from local controllers 1410A and 1410B, through the umbilical, through an SPI and synchronous serial communication protocol.

Referring to FIG. 15B remote controller 1402 will be further described.

Remote controller 1402 includes controller board 1401. In a preferred embodiment, controller board 1401 is a dedicated master Arduino Uno available from Arduino, LLC. In an alternate embodiment, remote controller 1402 may be a preconfigured controller, such as an FS-i6 system by FlySky Technology Co., Ltd. of Shenzhen, China.

Controller board 1401 comprises processor 1474 operatively connected to memory 1472. In an alternate embodiment, processor 1474 is further operatively connected to communications module 1476. Preferably, the communications module is a ESP8266 available from Seeed Technology.

Joystick 1403 and switch 1404 are operatively connected to processor 1474 through onboard connectors 1450. Preferably, joystick 1403 and switch 1404 are incorporated into a DFR00008 input shield available from DFRobot Corporation.

Joystick 1405 and switch 1406 are operatively connected to processor 1474 through onboard connectors 1450. Preferably, joystick 1405 and switch 1406 are incorporated into a DFR00008 input shield available from DFRobot Corporation.

Processor 1474 is further operatively connected to display 1470. Display 1470 displays video received from camera assembly 1288 and 1279, as will be further described. Display 1470 also displays status messages related to the input from the joysticks, switches, and status reports from the various motors and controllers of car assemblies 1108A and 1108B, as will be further described.

In use, input signals from joystick 1403, switch 1404, joystick 1405, and switch 1406 are received by processor 1474 and sent through the umbilical to local controllers 1410A and 1410B where they are relayed to motivate the functions of the immobilizers.

Referring to FIG. 15C, local controller 1410A will be further described.

Local controller 1410A preferably includes controller board 1411A. Preferably, controller board 1411A is an Arduino Uno available from Arduino, LLC.

Controller board 1411A includes processor 1482A operatively connected to memory 1484A.

Motor controllers 1450A, 1452A, 1454A, and 1456A communicate with processor 1482A through onboard connectors 1480A. Likewise, processor 1482A communicates with relay 1460 through connectors 1480A. Relay 1460 is operatively connected to motor 1262A and supplies operational current from the 12V DC source.

Camera assembly 1288 is operatively connected to processor 1482A through onboard connectors 1480A.

Processor 1482A is further operatively connected to communications module 1488A and display 1486A. In an alternate embodiment, communications module is a ESP8266 available from Seeed Technology. In this embodiment, communications module 1488A is wirelessly connected to communications module 1476, and is used to receive instructions from and relay status messages to controller board 1401.

In operation, processor 1482A receives control signals from remote controller 1402, interprets them, and sends them to the motor controllers and motors in order to control the operation of the immobilizer, as will be further described.

Referring to FIG. 15D, local controller 1410B will be further described.

Local controller 1410B preferably includes controller board 1411B. Preferably, controller board 1411B is an Arduino Uno available from Arduino, LLC.

Controller board 1411B includes processor 1482B operatively connected to memory 1484B.

Motor controller 1450B, 1452B, 1454B, and 1456B communicates with processor 1482B through onboard connectors 1480B. Likewise, processor 1482B communicates with relay 1462 through connectors 1480B. Relay 1462 is operatively connected to motor 1262B and supplies operational current from the 12V DC source.

Camera assembly 1279 is operatively connected to processor 1482B through onboard connectors 1480B.

Processor 1482B is further operatively connected to communications module 1488B and display 1486B. In an alternate embodiment, communications module is a ESP8266 available from Seeed Technology. In this embodiment, communications module 1488B is wirelessly connected to communications module 1476, and is used to receive instructions from and relay status messages to controller board 1401.

In operation, processor 1482B receives control signals from remote controller 1402, interprets them, and sends them to the motor controllers and motors in order to control the operation of the immobilizer, as will be further described.

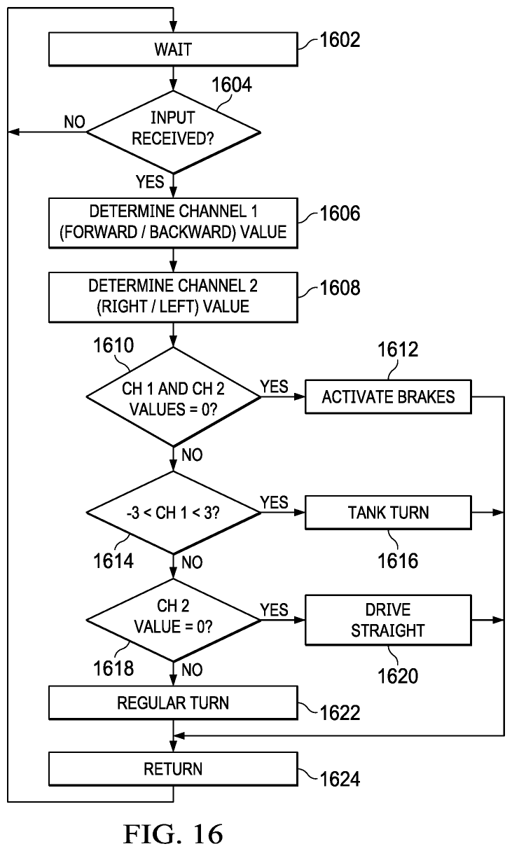

Referring then to FIG. 16, a preferred method of controlling a vehicle immobilizer will be further described.

At step 1602, the remote controller waits for input.

At step 1604, every 1-3 epochs the controller polls the joystick device for input. Preferably an epoch is 1 second, or 16 million clock cycles. If no input is received, the method returns to step 1602 and waits. If input is received, the method proceeds to step 1606. Input is transmitted from the joystick on two channels, one for an y-potentiometer and one for an x-potentiometer. Channel 1 input includes the y position of the joystick. The y position controls the forward and backward movement of the vehicle immobilizer, as will be further described. Channel 2 input includes the x position of the joystick. The x position controls the right and left movement of the vehicle immobilizer, as will be further described.

At step 1606, the controller determines the channel 1 value. Positive integers are used for forward directionality, and negative integers are used for backward directionality.

At step 1608, the controller determines the channel 2 value. Positive integers are used for right directionality, and negative integers are used for left directionality.

At step 1610, the controller queries whether or not the value of channel 1 and the value of channel 2 are both equal to 0. If so, the method proceeds to step 1612. If not, the method proceeds to step 1614.

At step 1612, an activate brakes command is generated by remote controller. At step 1624, the activate brakes command is transmitted to the motor controllers through the local controller to be actuated. The activate brakes command directs the motor controllers to activate the wheel unit brakes so the vehicle immobilizer will slow or stop. The method then returns to step 1602.

At step 1614, the controller queries whether or not the channel 1 value is greater −3 and less than 3. If so, the method proceeds to step 1616. If not, the method proceeds to step 1618.

At step 1616, a tank turn command is generated, as will be further described. At step 1624, the tank turn command is transmitted to the motor controllers through the local controller to be actuated. The method then returns to step 1602.

At step 1618, the controller queries whether or not the channel 2 value is equal to 0. If so, the method proceeds to step 1620. If not, the method proceeds to step 1622.

At step 1620, a drive straight command is generated, as will be further described. At step 1624, the drive straight command is transmitted to the motor controllers through the local controller to be actuated. The method then returns to step 1602.

At step 1622, a regular command is generated, as will be further described. At step 1624, the regular turn command is transmitted to the motor controllers through the local controller to be actuated. The method then returns to step 1602.

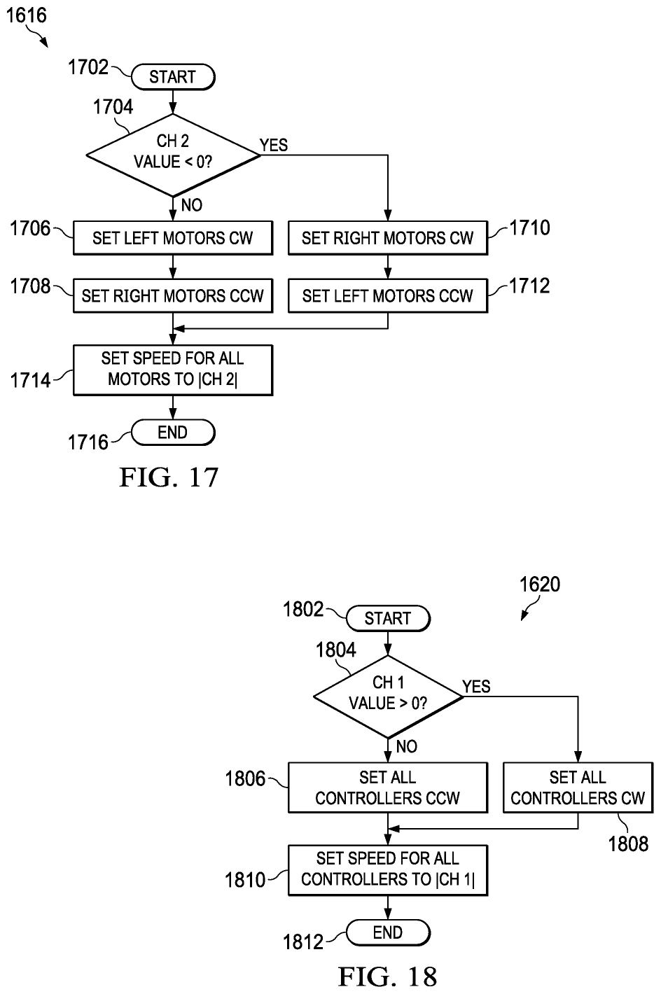

Referring then to FIG. 17, a preferred method for generating a tank turn command of step 1616 will be further described.

At step 1702, the method starts.

At step 1704, the controller queries whether or not the channel 2 value is less than zero. If so, the system is set for a left tank turn and the method proceeds to step 1710. If not, the system is set for a right tank turn and the method proceeds to step 1706.

At step 1706, the rotation direction for the left motor controllers is set to clockwise. At step 1708, the rotation direction for the right motor controllers is set to counterclockwise.

At step 1710, the rotation direction for the right motor controllers is set to clockwise. At step 1712, the rotation direction for the left motor controllers is set to counterclockwise.

At step 1714, the speed for all motor controllers is set to the magnitude of the channel 2 value.

At step 1716, the method ends.

Referring then to FIG. 18, a preferred method for generating a drive straight command of step 1620 will be further described.

At step 1802, the method starts.

At step 1804, the controller queries whether or not the channel 1 value is greater than zero. If so, the method proceeds to step 1808 and the system is set for forward movement. If not, the method proceeds to step 1806 and the system is set for backward movement.

At step 1806, the rotation direction for all motor controllers is set to counterclockwise.

At step 1808, the rotation direction for all motor controllers is set to clockwise.

At step 1810, the speed for all motor controllers is set to the magnitude of the channel 1 value.

At step 1812, the method ends.

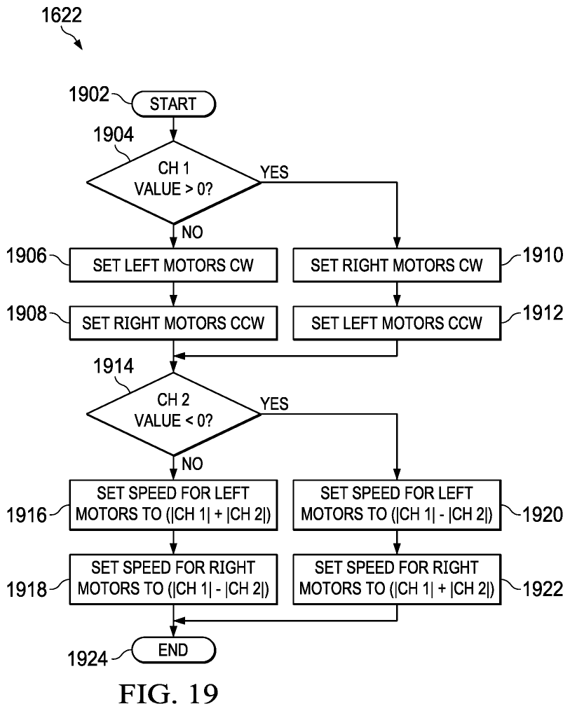

Referring then to FIG. 19, a preferred method for generating a regular turn command of step 1622 will be further described.

At step 1902, the method starts.

At step 1904, the controller queries whether or not the channel 1 value is greater than zero. If so, the method proceeds to step 1910. If not, the method proceeds to step 1906.

At step 1906, the rotation direction for the left motor controllers is set to clockwise. At step 1908, the rotation direction for the right motor controllers is set to counterclockwise.

At step 1910, the rotation direction for the right motor controllers is set to clockwise. At step 1912, the rotation direction for the left motor controllers is set to counterclockwise.

At step 1914, the controller queries whether or not the channel 2 value is less than zero. If so, the method proceeds to step 1920. If not, the method proceeds to step 1916.

At step 1916, the motor controller speed (MC Speed) for all left motor controllers is set according to the following equation:

MC Speed=|Ch1|+|Ch2|

Where:
   |Ch1| is the magnitude of the channel 1 value; and,
   |Ch2| is the magnitude of the channel 2 value.

At step 1918, the MC Speed for all the right motor controllers is set according to the following equation:

MC Speed=|Ch1|−|Ch2|

At step 1920, the MC Speed for all the left motor controllers is set according to the following equation:

MC Speed=|Ch1|−|Ch2|

At step 1922, the MC Speed for all the right motors is set according to the following equation:

MC Speed=|Ch1|+|Ch2|

At step 1924, the method ends.

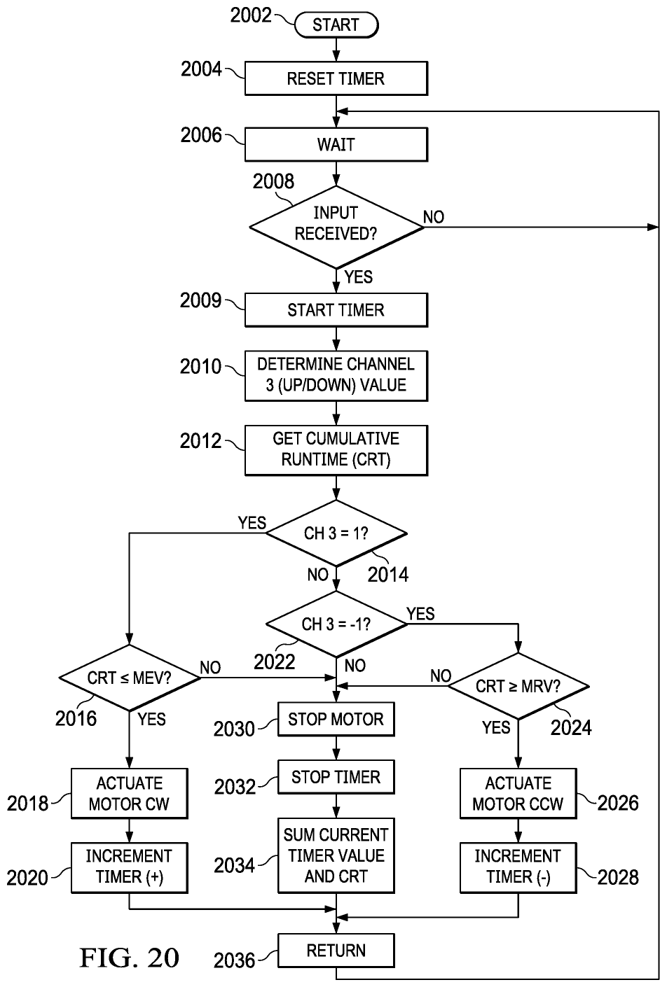

Referring then to FIG. 20, a preferred method for controlling a lift mechanism of a vehicle immobilizer will be described.

At step 2002, the method starts.

At step 2004, the controller resets a motor timer to zero.

At step 2006, the remote controller waits for input from the switches.

At step 2008, every 1-3 epochs the controller polls a switch for input. If no input is received, the method returns to step 2006 and waits. If input is received, the method proceeds to step 2009. Input is transmitted from the switch on a communication channel 3. Input is either 1, 0, or −1.

At step 2009, the motor timer is started.

At step 2010, the controller determines the channel 3 value. A positive one (1) is used for extended movement of the lift mechanism, zero (0) is used for no movement, and a negative one (−1) is used for retracted movement, of the lift mechanism.

At step 2012, the controller determines the current cumulative runtime (CRT). In a preferred embodiment, the CRT is an indication of the elapsed time during which a movement instruction has been received. CRT is utilized to prevent the lift mechanism from being extended or retracted too much by utilizing a maximum extended value and maximum retracted value, as will be further described. The maximum extended value and maximum retracted value are preset numbers stored in memory.

At step 2014, the controller queries whether or not the value of channel 3 is equal to 1. If so, the method proceeds to step 2016. If not, the method proceeds to step 2022.

At step 2016, the controller queries whether or not the current CRT is less than or equal to the maximum extended value (MEV). If not, the system proceeds to step 2030. If so, the method proceeds to step 2018.

At step 2018, the controller generates a lift command for the lift mechanism motors to actuate in a clockwise rotation. At step 2020, the timer is incremented by 1 epoch. At step 2036, the lift command is returned to the motors and the method returns to step 2006.

At step 2022, the controller queries whether or not the value of channel 3 is equal to −1. If so, the method proceeds to step 2024. If not, the method proceeds to step 2030.

At step 2024, the controller queries whether or not the current CRT is greater than or equal to the maximum retracted value (MRV). If not, the system proceeds to step 2030, and stops the motor. If so, the method proceeds to step 2026.

At step 2026, the controller generates a retract command for the lift mechanism motors to actuate in a counterclockwise rotation. At step 2028, the timer is decremented by 1 epoch. At step 2036, the retract command is returned to the motors and the method returns to step 2006.

At step 2030, the controller generates a stop motor command. At step 2032, the motor timer is stopped. At step 2034, the current timer value and the current CRT are summed to derive an updated CRT. At step 2036, the stop command is returned to the lift mechanism motors and the method returns to step 2006.

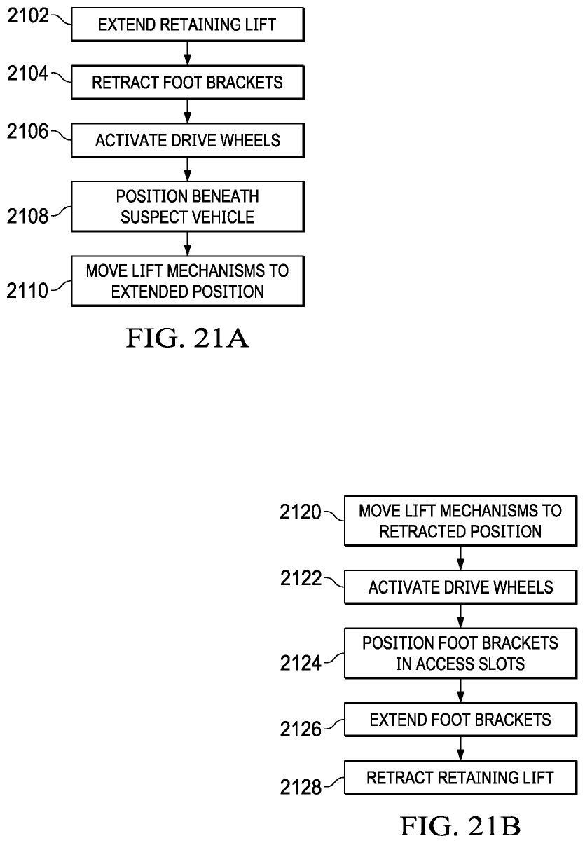

Referring then to FIG. 21A, a preferred method for deployment of an immobilizer will be described.

At step 2102, the retaining lift is extended.

At step 2104, the foot brackets are retracted.

At step 2106, the drive wheels are activated to move the immobilizer off of the retaining lift.

At step 2108, the vehicle immobilizer is positioned beneath the suspect vehicle.

At step 2110, the lift mechanism motors are activated to extend the lift mechanisms position and disable the suspect vehicle.

Referring then to FIG. 21B, a preferred method for securing a vehicle immobilizer in the retaining lift will be further described.

At step 2120, the lift mechanisms are retracted into a stowed position.

At step 2122, the drive wheels are activated to position the vehicle immobilizer on the retaining lift.

At step 2124, the foot brackets are positioned adjacent the access slots.

At step 2126, the foot brackets are extended into the access slots.

At step 2128, the retaining lift is retracted to its stowed position to secure the immobilizer.

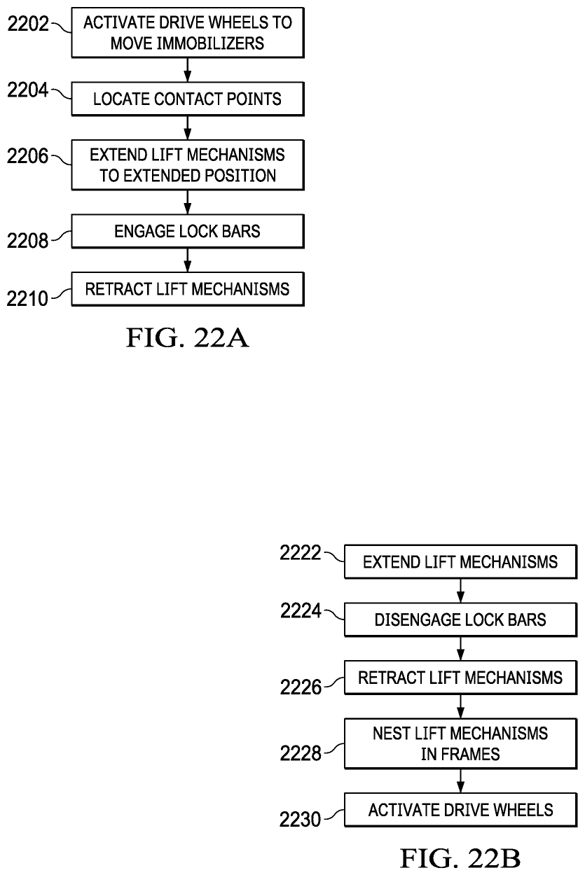

Referring then to FIG. 22A, a preferred method of disabling a suspect vehicle using the immobilizer system will be further described.

At step 2202, the drive wheels are activated to position the immobilizer beneath the suspect vehicle, guided by the remote controller.

At step 2204, the video feeds from the camara assemblies are used to position the centering cylinders beneath the contact points of the suspect vehicle. Ideally, contact points on each of the right rear wheel and the left rear wheel are located. Preferably, immobilizer 1100A is positioned beneath one contact point and immobilizer 1100B is positioned beneath the other. In another embodiment, both immobilizers may be positioned on the same side of the suspect vehicle. For example, beneath contact points adjacent the front wheel and rear wheel of either the right or left side of the suspect vehicle. Likewise, in another embodiment, contact points in the front the suspect vehicle adjacent the left and right front wheels may be targeted and used to lift the suspect vehicle.

At step 2206, the lift mechanism motors are activated to extend the lift mechanisms and at least partially lift and disable the suspect vehicle.

At step 2208, the lock bars are engaged to lock the lift mechanisms in place.

At step 2210, each retaining lift is retracted to transfer the weight of the suspect vehicle from the lifting mechanisms to the locking mechanisms.

Referring then to FIG. 22B, a preferred method of disengaging the immobilizer system from the suspect vehicle will be described.

At step 2222, the lift mechanisms motors are activated to extend the lift mechanisms.

At step 2224, the lock bars are disengaged. In one embodiment, the lock bars are disengaged by manually rotating each locking bar downward into a horizontal position.

At step 2226, the lift mechanism motors are reversed to retract the lift mechanisms.

At step 2228, the lift mechanisms are retracted into a nested position in the frames.

At step 2230, the drive wheels are activated to move the immobilizers out from under the suspect vehicle.

1. An immobilizer system for a vehicle comprising:
a frame;
a set of motorized drive wheels operatively supported by the frame;
a support plate rigidly attached to the frame;
a first lift mechanism, rigidly attached to the support plate;
a second lift mechanism, rigidly attached to the support plate; and,
whereby activation of the first lift mechanism and the second lift mechanism raises the support plate into contact with the vehicle and raises the set of motorized drive wheels away from a roadway surface.

2. The immobilizer system of claim 1 wherein a motorized drive wheel of the set of motorized drive wheels further comprises:
a road wheel;
a drive motor connected to the road wheel; and,
an axle connected to the drive motor.

3. The immobilizer system of claim 1 wherein motorized drive wheel is individually addressable.

4. The immobilizer system of claim 1 wherein the first lift mechanism further comprises a jack assembly.

5. The immobilizer system of claim 1 wherein the first lift mechanism further comprises:
a scissor jack assembly;
a set of trunnions operatively connected to the scissor jack assembly;
a drive screw operatively connected to the set of trunnions; and,
a lift motor, operatively connected to the drive screw.

6. The immobilizer system of claim 1 wherein the support plate further comprises:
a base plate;
a set of support beams fixed to the base plate; and,
a flexible surface cushion, adhered to the base plate, opposite the set of support beams.

7. The immobilizer system of claim 1 further comprising:
a pivotable retaining lift, adjacent the set of motorized drive wheels;
a first access slot, in the pivotable retaining lift, cradling the first lift mechanism; and,
a second access slot, in the pivotable retaining lift, cradling the second lift mechanism.

8. The immobilizer system of claim 7 wherein the pivotable retaining lift has a stowed position and a deployed position.

9. The immobilizer system of claim 1 further comprising:
a controller;
a memory, operatively connected to the controller;
a first switch, operatively connected to the controller;
a second switch, operatively connected to the controller;
the controller further operatively connected to the set of motorized drive wheels, the first lift mechanism and the second lift mechanism;
the memory further comprising a set of instructions, that when executed by the controller, cause the immobilizer system to:
activate the set of motorized drive wheels when a first signal is received from the first switch; and,
activate the first lift mechanism and the second lift mechanism when a second signal is received from the second switch.

10. The immobilizer system of claim 9 wherein the memory contains further instructions that when executed cause the immobilizer system to:
execute a limit stop, on the first lift mechanism, based on a timer.

11. The immobilizer system of claim 1 wherein the set of motorized drive wheels is arranged in two diametrically opposed pairs of motorized drive wheels.

12. An immobilizer system for a vehicle comprising:
a frame;
a set of motorized drive wheels operatively supported by the frame;
a docking assembly, removably supported by the frame;
a lift mechanism, removably nested in the frame, and rigidly attached to the docking assembly; and,
whereby activation of the lift mechanism removes the lift mechanism from the frame and positions the docking assembly into contact with the vehicle and a roadway surface.

13. The immobilizer system of claim 12 wherein a motorized drive wheel of the set of motorized drive wheels further comprises:
a road wheel;
a drive motor connected to the road wheel; and,
an axel operatively connected to the drive motor.

14. The immobilizer system of claim 13 wherein the motorized drive wheel is individually addressable.

15. The immobilizer system of claim 12 wherein the lift mechanism further comprises:
a powered jack assembly;
a set of lock bars, rotatable between the powered jack assembly and the docking assembly; and,
the set of lock bars having an unengaged position whereby the docking assembly is not supported by the set of lock bars and an engaged position whereby the docking assembly is supported by the set of lock bars.

16. The immobilizer system of claim 15 wherein the docking assembly further comprises:
a contact plate; and,
a lock plate, adjacent to the contact plate, and releasably fixed in position by the set of lock bars.

17. The immobilizer system of claim 16 wherein the lock plate further comprises a centering cylinder, protruding through the contact plate.

18. The immobilizer system of claim 17 wherein the centering cylinder further comprises an electronic camera system for positioning the docking assembly.

19. The immobilizer system of claim 12 further comprising:
a controller;
a memory, operatively connected to the controller;
a first switch, operatively connected to the controller;
a second switch, operatively connected to the controller;
the controller further operatively connected to the set of motorized drive wheels and the lift mechanism;
the memory further comprising a set of instructions, that when executed by the controller, cause the immobilizer system to:
activate the set of motorized drive wheels when a first signal is received from the first switch; and,
activate the lift mechanism when a second signal is received from the second switch.

20. The immobilizer system of claim 19 wherein the memory contains further instructions that when executed cause the immobilizer system to:
execute a limit stop on the lift mechanism based on a timer.

21. The immobilizer system of claim 19 wherein the set of motorized drive wheels further comprises two pairs of diametrically opposed motorized drive wheels.

22. A method of suspending a suspect vehicle by an immobilizer system comprising:
providing a frame;
providing a set of motorized drive wheels operatively supported by the frame;
providing a support plate rigidly attached to the frame;
providing a first lift mechanism, rigidly attached to the support plate;
providing a second lift mechanism, rigidly attached to the support plate;
activating the set of motorized drive wheels to position the immobilizer system beneath the suspect vehicle; and,
activating the first lift mechanism and the second lift mechanism to raise the support plate to a position in contact with the suspect vehicle while simultaneously positioning the first lift mechanism and the second lift mechanism on a roadway surface and raising the set of motorized drive wheels away from the roadway surface.

23. The method of claim 22 further comprising:
attaching a pivotable retaining lift to an official vehicle;
providing a set of generally parallel slots in the pivotable retaining lift;
stowing the immobilizer system in the pivotable retaining lift by positioning the first lift mechanism and the second lift mechanism in the set of generally parallel slots; and,
deploying the immobilizer system by pivoting the pivotable retaining lift, retracting the first lift mechanism and the second lift mechanism and activating the set of motorized drive wheels.

24. The method of claim 22 further comprising:
providing a motorized drive wheel of the set of motorized drive wheels with:
a road wheel;
a drive motor connected to the road wheel; and,
an axle connected to the drive motor.

25. The method of claim 22 further comprising:
Providing the first lift mechanism with a jack assembly.

26. A method of suspending a suspect vehicle by an immobilizer system comprising:
providing a first remotely operated transport car, supporting a first removable lift jack;
providing a second remotely operated transport car, supporting a second removable lift jack;
moving the first remotely operated transport car to a first position under the suspect vehicle;
moving the second remotely operated transport car to a second position under the suspect vehicle;
extending the first removable lift jack, out of the first remotely operated transport car and into contact with the suspect vehicle and a roadway surface; and,
extending the second removable lift jack, out of the second remotely operated transport car and into contact with the suspect vehicle and the roadway surface.

27. The method of claim 26 further comprising:
providing a first locator camera on the first removable lift jack;
using the first locator camera to position the first remotely operated transport car relative to the suspect vehicle;
providing a second locator camera on the second removable lift jack; and,
using the second locator camera to position the second remotely operated transport car relative to the suspect vehicle.

28. The method of claim 27 further comprising:
providing the first removable lift jack with a rotatable lock bar for supporting the suspect vehicle; and,
retracting the first removable lift jack, thereby supporting the suspect vehicle with the rotatable lock bar.

29. The method of claim 28 further comprising the step of:
providing a docking plate, operatively connected to the first removable lift jack, supported by the rotatable lock bar.

30. The method of claim 29 further comprising:
nesting the first removable lift jack in a first cavity in the first remotely operated transport car; and,
nesting the second removable lift jack in a second cavity in the second remotely operated transport car.
